(19) United States
(12) Patent Application Publication
(10) Pub. No.: US 2024/0008678 A1
(43) Pub. Date: Jan. 11, 2024

(54) APPARATUS AND METHOD FOR BEVERAGE BREWING

(71) Applicant: Robert D. Jacobs, Franklin, NY (US)

(72) Inventor: Robert D. Jacobs, Franklin, NY (US)

(21) Appl. No.: 17/857,794

(22) Filed: Jul. 5, 2022

(51) Int. Cl. A47J 31/44; A47J 31/06

(52) U.S. Cl. CPC A47J 31/446; A47J 31/06

(57) ABSTRACT

According to present invention, a basket for brewing coffee is disclosed. The basket includes an interior volume intended to receive an amount of ground coffee. The basket includes a plurality of openings that are sized to permit water to pass therethrough but to retain ground coffee in the interior volume. The basket includes at least one attachment point for attaching to a complementary connector on the coffee machine. The coffee machine includes a complementary connector intended to be inserted into the attachment point on the basket containing ground coffee. The attachment point and complementary connector enable a user to attach and detach a basket filled with coffee grounds to the coffee machine in a quick and efficient manner.

### FIELD OF THE INVENTION

The invention relates to brewing coffee and other beverages and, more specifically, to providing an apparatus and method for brewing coffee that is more efficient than the coffee brewing systems of the prior art and that produces a higher quality coffee than can be produced by the coffee brewing systems that the industry currently offers.

### BACKGROUND OF THE INVENTION

Coffee's Ubiquity & Availability

Coffee is one of the most popular drinks in America. A 2015 Gallup poll found that nearly two-thirds (64%) of Americans drink at least one cup of coffee per day. See http://www.gallup.com/poll/184388/americans-coffee-consumption-steady-few-cut-back.aspx. More telling, the same poll found that the average coffee drinker in America drinks nearly three full cups of coffee each and every day. Id.

Given coffee's wild popularity across the country, it is not surprising that coffee drinkers have more options for obtaining a cup of coffee than ever before. Today, coffee drinkers can purchase a cup of coffee at name-brand commercial coffee shops, like Starbucks and Dunkin Donuts; gas stations; street vendors; at fast food locations, such as McDonald's (as well as at almost any food serving establishment); and at numerous other locations (all locations at which a coffee drinker may purchase coffee outside of their home are collectively referred to hereafter as “coffee shops”). And research suggests that coffee drinkers indeed swarm coffee shops. Trade magazines report that the average Starbucks serves over 500 customers each day and Dunkin Donuts reports that is sells nearly 2 billion cups of coffee in America each year. http://www.businessinsider.com/how-many-customers-starbucks-will-have-201-3-10; https://news.dunkindonuts.com/news/brand-keys-names-dunkin-donuts.

Despite the ubiquity of coffee shops, the overwhelming majority of American coffee drinkers still make their coffee at home. See, e.g., https://www.aol.com/2011/01/25/savings-experiment-the-perks-of-brewing-ve-rsus-buying-coffee/. Making coffee at home offers numerous advantages. The most notable advantage is cost: making coffee at home is drastically cheaper than buying it at coffee shops. The average cost of a cup of coffee that is purchased on-the-go ranges between $2-$5. The average cup of coffee brewed at home, however, costs on average only 16 to 22 cents depending on how much you spend per pound to buy the coffee. For example, at $8 per pound (a common price for many types of coffee in typical US grocery stores), the average 10 cup per day user spends $0.20 per cup. Not surprisingly, numerous publications that advise consumers about how to increase their savings counsel consumers to make coffee at home rather than paying the comparatively high prices charged by coffee shops.

However, there may be a drawback that at-home coffee drinkers may face is poor quality and taste, which can also be a problem at coffee shops. Many people believe that the beans that a person uses will dictate the quality and taste of coffee brewed at home. While bean quality is a factor that impacts taste, the factor that can overwhelmingly influence the quality and taste of coffee is the method of brewing.

In addition, in some instances, a user may wish to enjoy the benefits of the coffee brewing process of the present invention but may already own a vessel in which to heat, brew, store and/or dispense the coffee from. In other instances, a user may wish to cold brew coffee at room temperature or cooler. The present invention addresses the above known shortcomings, as well as others, in the art.

### SUMMARY OF THE INVENTION

According to one aspect of the present invention, a basket for holding coffee grounds is disclosed that includes a frame, an amount of coffee grounds, and at least one attachment point. The frame defines at least one outer wall. The outer wall defines an enclosed interior volume. The amount of coffee grounds is positioned in the interior volume. The frame includes at least one attachment point on a side of the frame. The at least one attachment point includes an opening sized to receive a complementary connector provided on a coffee brewing machine for the purpose of selectively attaching and detaching the basket to the coffee machine during normal use. The frame includes a plurality of holes that generally permit water to ingress and egress the frame while substantially prevents the amount of coffee from exiting the frame during the normal brewing process.

According to another aspect of the invention, the basket may include two or more attachment points. The two attachment points may be on the same side of the basket or on different sides of the basket.

According to a further aspect of the invention, the attachment points in some embodiments, define a through hole while, in other embodiments, define a substantially enclosed cavity.

According to an even further aspect of the invention, the basket frame can made from materials such as bamboo, plastic and/or metal.

According to an even further aspect of the invention, the direction of entry into the attachment point may vary depending on the wants and needs of the designer.

According to an even further aspect of the invention, the attachment point(s) can connect to the complementary connector(s) via, e.g., a press fit connection or a positive engagement (such as a latch).

According to an even further aspect of the invention, the basket may include an opening into which a user may add the coffee grounds prior to brewing the coffee. The opening could be, for example, a door, or the basket may have two components that can be selectively attached and detached from one another.

One advantage of the present invention is that the basket can be easily installed prior to use.

Another advantage of the present invention is that the basket is easily detached from the machine with minimal mess.

These and other advantages will be apparent to one of skill in the art in light of the present disclosure and drawings.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows an isometric view of the apparatus of the first embodiment of the present invention.

FIG. 2 shows a view of the means for agitating the basket stored within the water chamber of the first embodiment of the present invention.

FIG. 3 shows a cross sectional view of the apparatus of the first embodiment of the present invention.

FIG. 4 shows an isometric view of the apparatus of the first embodiment of the present invention and shows how the apparatus may be opened to remove the basket.

FIG. 5 shows a view of the water chamber, basket, means for agitating, and how the top of the apparatus may open to remove the basket in the first embodiment of the present invention.

FIG. 6 shows how the basket may be removed from the apparatus in the first embodiment of the present invention.

FIG. 7 shows how the means for heating the water chamber may be included in the apparatus of the first embodiment of the present invention.

FIG. 8 shows the packet in which coffee grounds are stored in some of the embodiments of the present invention.

FIG. 9 shows the apparatus of the second embodiment of the present invention.

FIG. 10 shows components of the apparatus, including the basket and means for agitating the basket of the second embodiment of the present invention.

FIG. 11 shows components of the apparatus and how the basket may be opened in the second embodiment of the present invention.

FIG. 12 shows an example of how the components of the apparatus function to achieve agitated infusion in the second embodiment of the present invention.

FIG. 13 shows how external heat may be applied to heat water within the apparatus of the second embodiment of the present invention.

FIG. 14 shows an embodiment of the apparatus that includes a means for displaying the temperature of liquid within the apparatus of the second embodiment of the present invention.

FIG. 15 shows an embodiment of the apparatus that includes a mean for heating liquid within the apparatus of the second embodiment of the present invention.

FIGS. 16A and 16B show how the basket may be opened and closed via a latch in the second embodiment of the present invention.

FIGS. 17A and 17B show how the basket may be opened and closed via a “twist-lock” of the second embodiment of the present invention.

FIG. 18 shows an overhead view of one embodiment of a basket with a baffle;

FIG. 19 shows a side cut-away view of one embodiment of a basket with a baffle connected to the side wall;

FIG. 20 shows a side cut-away view of one embodiment of a basket with a baffle connected to the bottom wall;

FIG. 21 shows a side cut-away view of one embodiment of a basket with a baffle connected to the lid of the basket;

FIG. 22 shows a side cut-away view of a basket with a baffle that includes at least a portion of one wall having a bend therein;

FIG. 23 shows a side cut-away view of a basket with a baffle that includes at least a portion of one wall having multiple bends therein;

FIG. 24 shows an isometric view of the third embodiment of the present invention with the apparatus on the pre-existing vessel.

FIG. 25 shows an isometric view of the apparatus of the third embodiment of the present invention.

FIG. 26 shows an isometric view of the apparatus of the third embodiment of the present invention with the optional heat source present.

FIG. 27 shows a cross-sectional schematic view of FIG. 24 along line 27-27.

FIG. 28 shows an isometric view of one version of the fourth embodiment of the present invention.

FIG. 29 shows an isometric view of the frame, basket and means for agitating the basket of one version of the fourth embodiment of the present invention.

FIG. 30 shows a cross-sectional schematic view of FIG. 28 along line 30-30.

FIG. 31 shows an isometric view of a second version of the fourth embodiment of the present invention.

FIG. 32 shows a cross-sectional schematic view of FIG. 30 along line 32-32.

FIG. 33 shows an isometric view of a basket with at least one attachment point.

FIG. 34A shows an isometric view of the basket of FIG. 33 selectively attached to a connector body.

FIG. 34B shows a second isometric view of the basket of FIG. 33 selectively attached to a connector body.

FIG. 35 shows an isometric view of a basket with at least one attachment point where the attachment point includes a through hole.

FIG. 36 shows an isometric view of a basket with at least one attachment point where the attachment point includes a cavity and a partial cut-out to show the inner cavity.

FIG. 37 shows an isometric view of a basket with at least one attachment point where the attachment point includes a generally vertical direction of entry to the attachment point.

FIG. 38 shows an isometric view of a first connector body.

FIG. 39 shows an isometric view of a connector body.

FIG. 40 shows a front view of a basket with at least one attachment point.

FIG. 41 shows an isometric view of the basket of FIG. 40 selectively attached to the connector body of FIG. 39.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current technology, it will become necessary to select certain terminology when referring to and describing relevant components within the coffee or beverage brewing industry. To the extent possible, common industry terminology will be used and employed in a manner consistent with its accepted meaning.

Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows.

It is often required to describe parts that are disposed at differing radial positions with regard to a center axis. The term “radial” refers to movement or position perpendicular to an axis. For example, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis. It will be appreciated that such terms may be applied in relation to the center axis of the turbine.

In addition, several descriptive terms may be used regularly herein, as described below. The terms “first”, “second”, and “third” may be used interchangeably to distinguish one component from another and are not intended to signify location or importance of the individual components.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Where an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g. “between” versus “directly between,” “adjacent” versus “directly adjacent,” etc.). As used herein, the term “and/or” includes any and all combinations of one or more of the associated listed items.

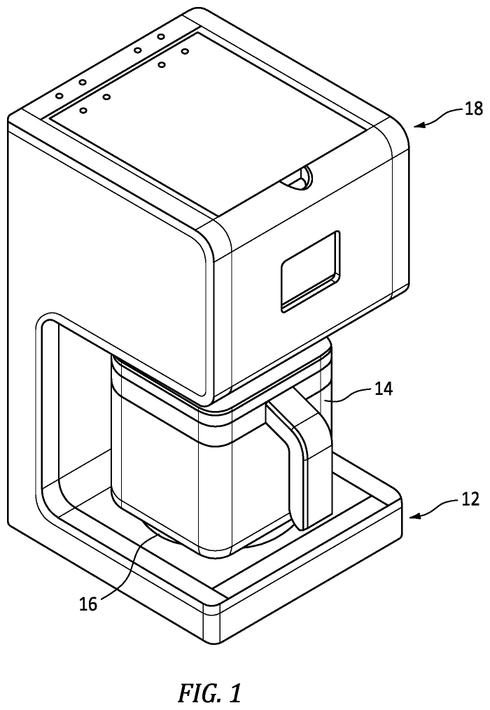

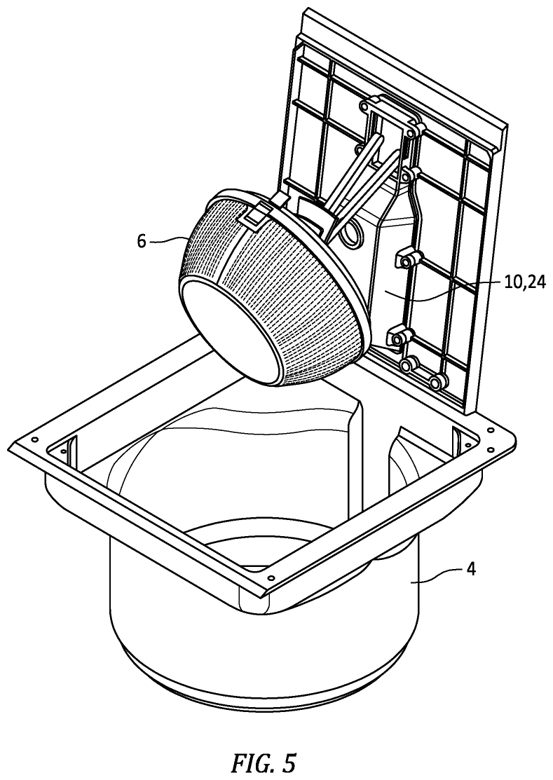

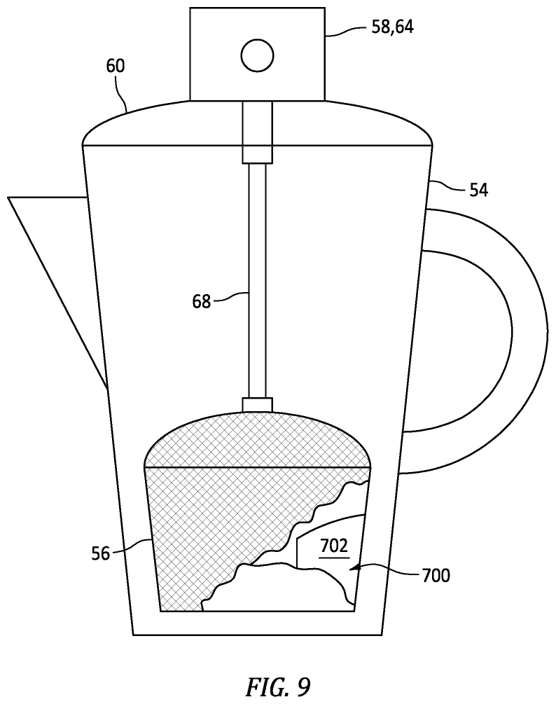

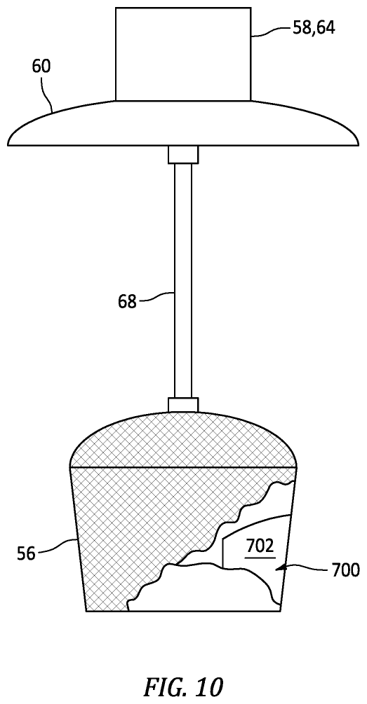

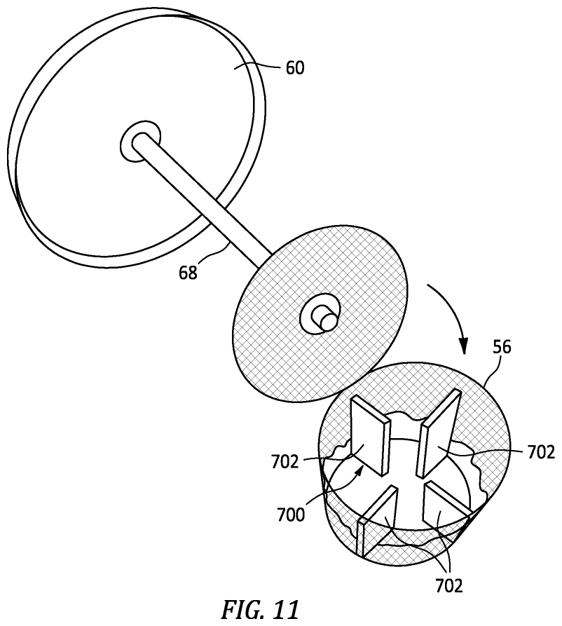

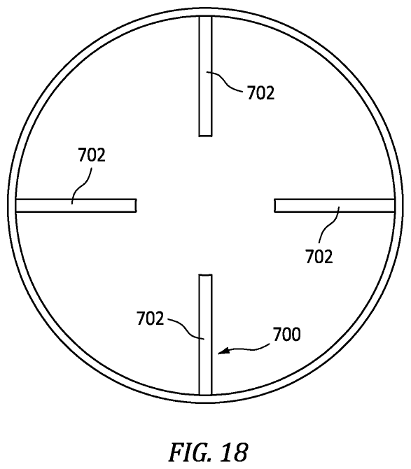

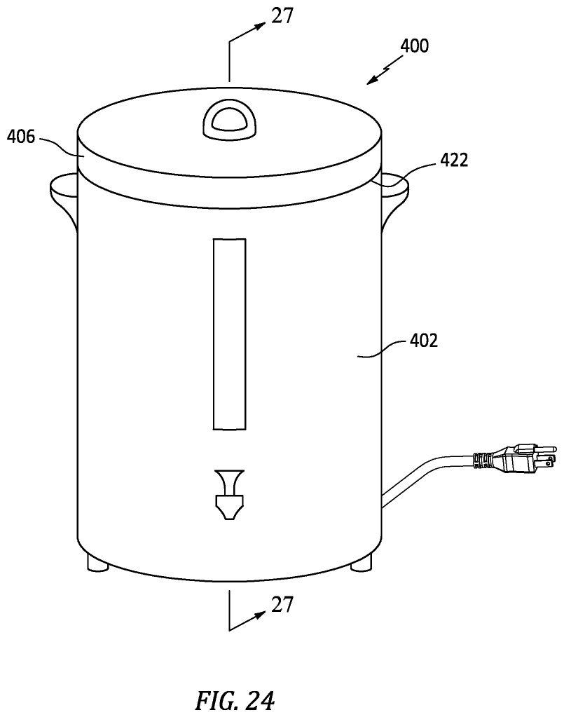

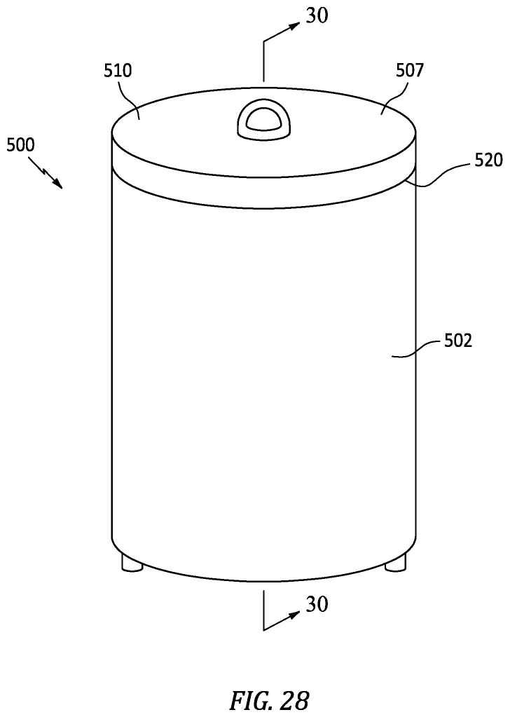

The present invention combines all of the best practices for brewing coffee into a single system. But before describing the components of the present invention for brewing coffee, it is important to describe how coffee grounds are used in the present invention. Several embodiments are shown and disclosed herein. For example, a first embodiment is shown and described in FIGS. 1-8, a second embodiment is shown and described in FIGS. 9-17B, a third embodiment in FIGS. 24-27 and a fourth embodiment in FIGS. 28-32. The baffle 700 of the present invention is shown and described in FIGS. 18-23.

Brewing System Components

Now speaking of the components that comprise the first embodiment, as shown in FIG. 1, from the outside, the look of the present invention resembles many drip coffee systems currently available. But the components within the present system, which are responsible for brewing the coffee, create a coffee brewing system and method for brewing coffee that are novel to the industry.

With respect to the components of the second embodiment, as shown in FIG. 9, from the outside, the look of the present invention resembles percolator systems currently available. But the components within the present system, which are responsible for brewing the coffee, create a coffee brewing system and method for brewing coffee that are novel to the industry.

Structure Generally

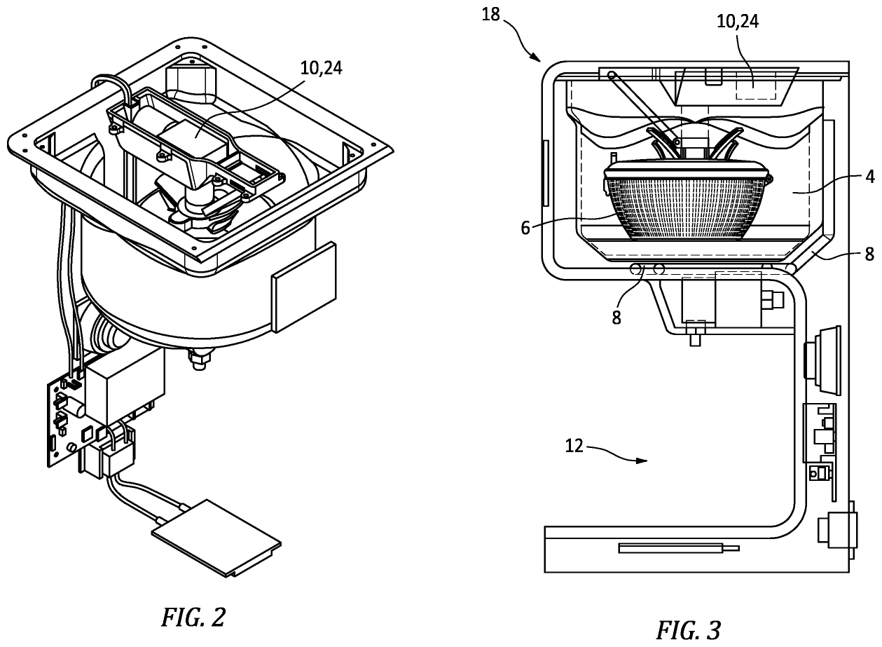

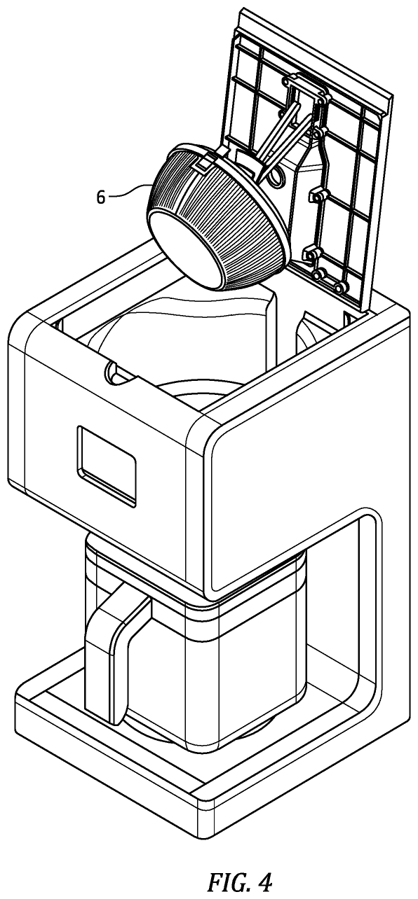

With respect to the first embodiment, as shown in FIGS. 2 and 3, the includes a free-standing structure that includes an “upper portion” 18 that houses a water chamber 4, basket 6, heating means 8, and a means for agitating the basket 10. The invention also includes a “lower portion” 12 that is fashioned so that a carafe 14 (see FIG. 1) or other storage receptacle (including a user's mug) may be situated below the water chamber 4 that is located within the upper portion. The lower portion may optionally include a means 16 (see FIG. 1) for keeping warm any liquid that is stored in the storage receptacle that may be placed below the water chamber.

As shown in FIG. 9, the second embodiment includes a carafe 54 that is similar or identical to the carafe used in a percolator system, a basket 56, and a means for agitating 58 the basket 56. To add water to the carafe 54, the user merely removes the carafe's lid 60 and pours water therein.

The Basket

With respect to the first embodiment, and as shown in multiple FIGS included herewith, the upper portion of the present invention includes a chamber 4 for holding water. The water chamber 4 may be formed in any shape that enables the present invention to function as described and claimed herein. The present invention may be manufactured so that the user accesses the water chamber 4 by opening any portion of system's upper portion, such as a side panel or the system's top panel. FIGS. 4, 5, and 6 show a preferred embodiment wherein the top panel of the upper portion may be opened to access the water chamber 4. For example, it would be suitable for the top panel to be hinged relative to the remainder of the upper portion 18. The water chamber 4 may be manufactured from a variety of materials and those of skill in the art will recognize suitable materials from which to manufacture the water chamber 4. In a preferred embodiment of the invention, the water chamber 4 is manufactured from stainless steel. Manufacturing the water chamber 4 from stainless steel is advantageous because the chamber will be resistant to corrosion and heat damage, which may otherwise pose problems because the present system heats water within the chamber to a high temperature. In addition, the strength of stainless steel permits the water chamber 4 to be manufactured with thinner walls than would be possible using other materials, which results in a cost savings and allows the overall size of the present system to be reduced, which consumers often prefer.

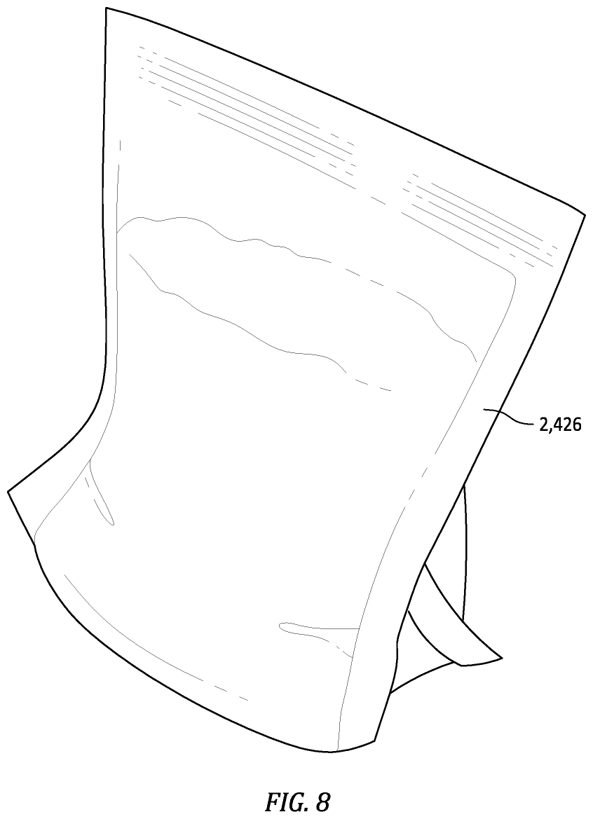

Within the water chamber 4, the present invention includes a “basket” 6 into which the user places coffee grounds. The coffee grounds are preferably placed in the basket loose; however, the user can place the coffee grounds in the basket inside a pre-filled packet as shown, for example, in FIG. 8. An example of the basket 6 can be seen in FIGS. 4, 5 and 6. The basket 6 must be manufactured so that a user may insert coffee grounds into the basket 6 and, when brewing is complete, remove the coffee grounds from the basket prior to a subsequent use. Those with skill in the art will recognize that there are numerous ways in which the basket 6 may be manufactured so that the coffee grounds, regardless of whether or not a packet is utilized, can be inserted and removed, and all such numerous ways are considered within the scope of the present invention.

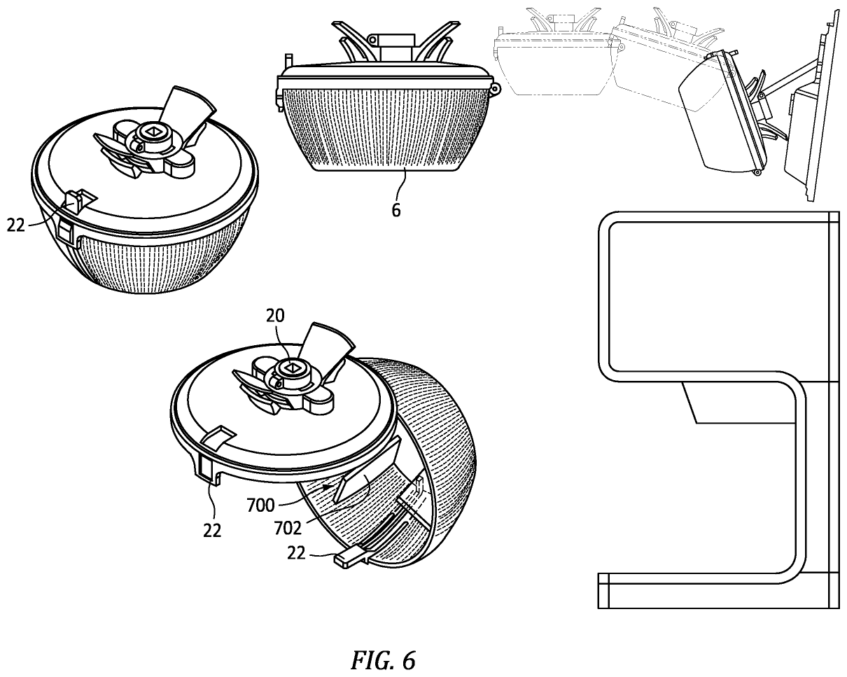

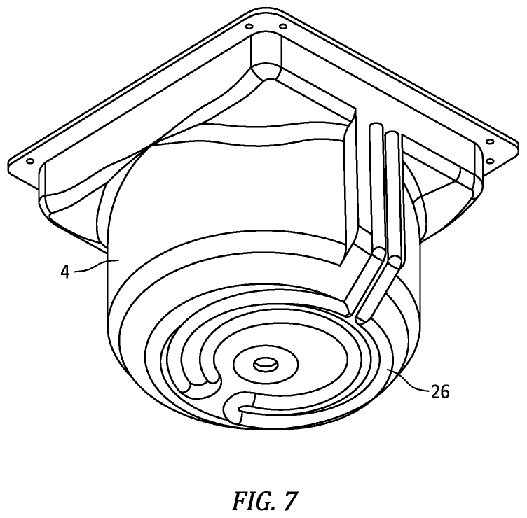

The basket 6 must also be manufactured such that water may enter the basket and inundate the coffee grounds. There are numerous methods of manufacturing the basket 6 so that water may enter it to inundate the coffee grounds, and those with skill in the art will recognize that such numerous methods exist (all such numerous methods are considered within the scope of the present invention). In a preferred embodiment shown in FIG. 6, the basket 6 is comprised of wire mesh that permits water to enter and exit the basket 6. Other options include but are not limited to fabricating the basket such that it has “holes” or “slits” that permit water to enter the basket to inundate the packet.

As shown in FIG. 6, the present system may be manufactured so that the basket 6 may be removed from the water chamber 4 (and indeed may be removed from the entire apparatus). Enabling the basket 6 to be removed from the apparatus allows the user to more easily discard the used coffee grounds once brewing is complete. Those with skill in the art will recognize that there are numerous means by which the basket 6 may be secured within the water chamber 4 so that it may be removed from the chamber 4 and all such means should be considered within the scope of the present invention. In one possible embodiment shown in FIG. 6, the basket 6 connects to the water chamber 4 via a “universal joint” 20, which is a type of joint well known in the art that allows the basket to be easily disengaged from the water chamber 4 and entirely removed from the system. An additional example of a connection that may be employed is a hooked axle, which also allows the basket to be easily disengaged from the water chamber 4 and entirely removed therefrom. These are, however, only two of the many means of connecting the basket to the water chamber 4 or, as explained below, to a motor that is connected to the water chamber 4, and all such means are considered within the scope of the present invention.

In addition, the basket 6 may be manufactured so that it can easily discard the coffee grounds after use. This may be accomplished by numerous methods, all of which are well known in the art and all of which are considered within the scope of the present invention. For example, as shown in FIG. 6, the basket 6 may include a “release latch” 22, whereby when a release button is pressed, the latch is released and the basket 6 opens. Additional types of latches, such as a hook latch may also be used.

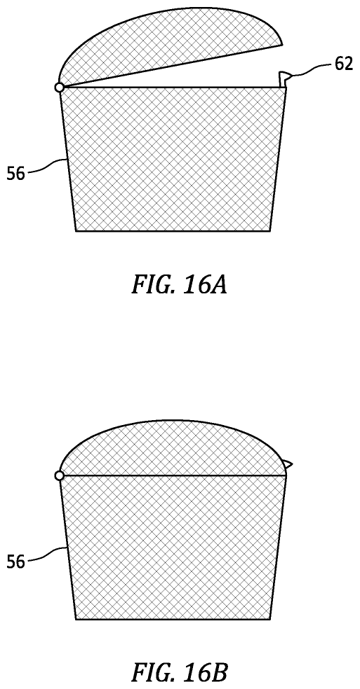

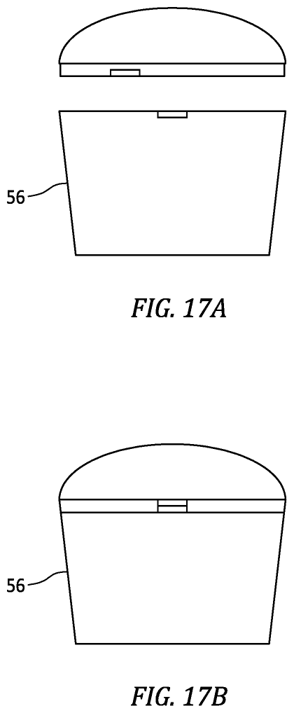

Turning now to the second embodiment, the basket 56 operates in a similar manner to the basket 6 of the first embodiment. In this embodiment, the basket 56 also receives the coffee grounds placed therein by the user. An example of the basket 56 can be seen in several FIGS included herewith (for example, FIGS. 9-13). The basket 56, as was the case in the first embodiment, may be manufactured so that a user may place an amount of coffee grounds into the basket and, when brewing is complete, remove the amount of coffee grounds from the basket. Those with skill in the art will recognize that there are numerous ways in which the basket may be manufactured so that the coffee grounds can be inserted and removed, and all such numerous ways are considered within the scope of the present invention. Examples of such numerous ways are discussed below and shown in FIGS. 16A, 16B, 17A, and 17B.

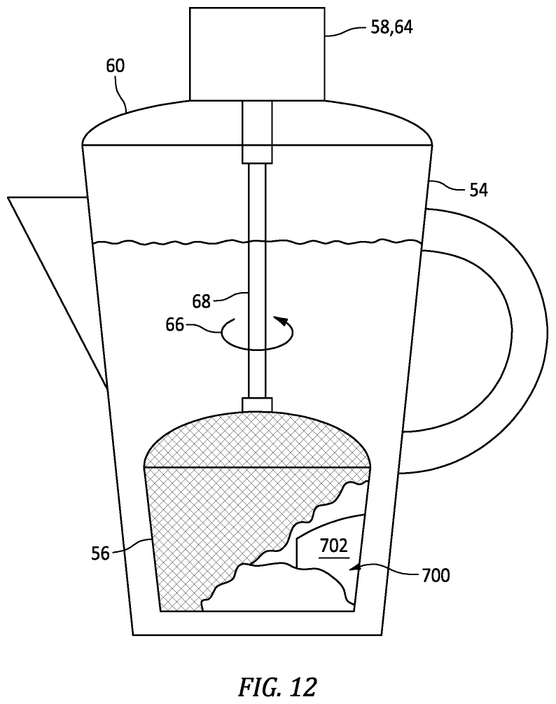

The basket 56 must also be designed and manufactured such that water may enter the basket and inundate the coffee grounds. There are numerous methods of manufacturing the basket so that water may enter it to inundate the coffee grounds, and those with skill in the art will recognize that such numerous methods exist (all such numerous methods are considered within the scope of the present invention). In a preferred embodiment shown in FIG. 12 (as well as in other Figures), the basket 56 is comprised of wire mesh that permits water to enter and exit the basket. Other options include but are not limited to fabricating the basket such that it has “holes” or “slits” that permit water to enter the basket to inundate the packet.

In addition, the basket 56 may be manufactured so that it can easily discard the coffee grounds and so that the coffee grounds can be easily placed therein. This may be accomplished by numerous methods, all of which are well known in the art and all of which are considered within the scope of the present invention. For example, as shown in FIGS. 8A and 8B, the basket 56 may include a “release latch” 62, whereby when a release latch 62 is pressed, the latch 62 is released and the basket 56 opens. Other types of latches can be employed as well. For example, a hook latch may also be used. In addition, as shown in FIGS. 9A and 9B, the basket may be manufactured to include a “twist lock.” Twist locks are well known in the art; they function such that when one component of an apparatus is inserted into or joined with a second component, and one or both of the components are rotated, the structure of the two components causes the two components to be securely fastened together. Two of the many examples of how twist locks function include threading (similar to the caps of many common bottles of drinking water) or a latching mechanism (such as the release latch mechanism described above).

The basket 56 may be manufactured from a variety of materials and those of skill in the art will recognize suitable materials from which to manufacture the basket. In a preferred embodiment of the invention, the basket is manufactured from stainless steel. Manufacturing the basket from stainless steel is advantageous because the basket will be resistant to corrosion and heat damage, which may otherwise pose problems because the present system heats water within the carafe to a high temperature. In addition, the strength of stainless steel permits the basket to be manufactured with thinner walls than would be possible using other materials, which results in a cost savings, which consumers often prefer.

As shown in FIGS. 16A, 16B, 17A, and 17B, the present system may be manufactured so that the basket 56 may be removed from the apparatus. Enabling the basket 56 to be removed from the apparatus allows the user to more easily discard the used packet 52 once brewing is complete. Those with skill in the art will recognize that there are numerous means by which the basket 56 may be removed from the apparatus and all such means should be considered within the scope of the present invention. In one possible embodiment (shown in FIG. 4 and discussed supra), the basket 56 connects to the means for agitation 58 by an elongated member 68 (e.g., a shaft). In such embodiment, there are numerous means by which the elongated member may be connected to the basket 56; for example, the basket 56 may be connected to the member 68 via a “universal joint,” as described in connection to the first embodiment. Or, as also was described in connection with the first embodiment, a hooked axle could, for example, be utilized.

The Baffle

During normal operation, the basket in each of embodiments one through four of the present disclosure is agitated as discussed in greater detail infra. It has been found that in some instances where the coffee grounds are positioned in the basket—with or without a packet— and the basket is, e.g., rotated, the coffee grounds are not sufficiently agitated. Rather, the coffee grounds remain generally stationary in the water while the basket is agitated around them. In these instances, the resulting brewed coffee lacks the quality of a brewed beverage when the coffee grounds are sufficiently agitated in the water. It has been shown that adding a baffle 700 to the inside of the basket can solve the above issue and can provide numerous advantages. For example, the baffle 700 wall(s) 702 tend to force the coffee grounds (or packet containing coffee grounds) to move with the basket during operation. Baffle 700 and the associated baffle wall(s) 702 can be seen in at least FIGS. 6, 9, 10-13, 18-23, 27, 30 and 32. The movement of the coffee grounds forces enhanced interaction between the coffee grounds and the water. In addition, various features of the baffle 700 cause increased turbulence in the water inside the basket when the baffle 700 and basket are agitated. The increased disturbance of the water due to the baffle 700 during operation further enhances the interaction between the coffee grounds and the water during the brewing process.

The baffle 700 walls 702 may be made of any suitable materials including, but not limited to, plastics or metal. In addition, each wall 702 may be generally solid or may include holes. In instances where a baffle 700 wall 702 includes holes, the holes preferably are sized large enough to permit water to flow therethrough, but small enough to generally prevent coffee grounds from passing threrethrough.

The baffle 700, as described herein, is intended to be utilized with the basket in each of embodiments one through four.

Referring now to FIGS. 18-23, a baffle 700 is shown. The baffle 700 includes one or more walls 702 that are positioned interior to the basket during operation. The baffle 700 may be permanently connected to the basket or may be removably attachable to the basket. In embodiments where the baffle 700 is removable from the basket, it is preferable that the baffle 700 and the basket include complementary attachment features to ensure that the one or more walls 702 of the baffle 700 move with the basket when the basket is agitated.

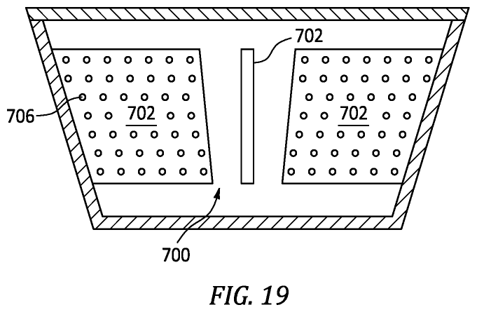

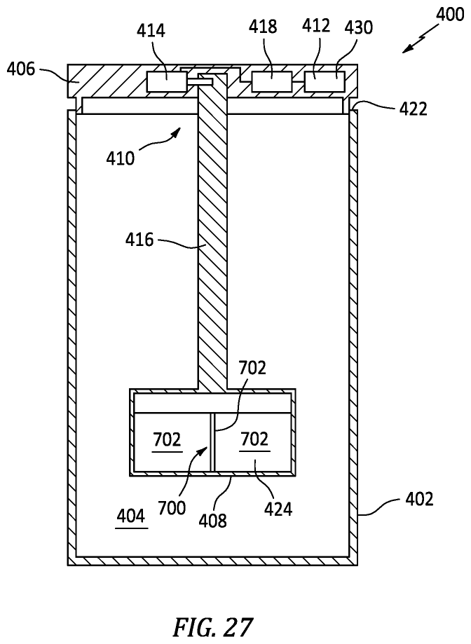

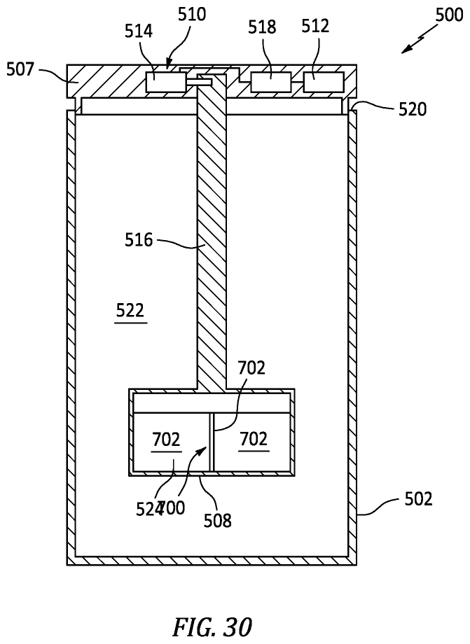

Referring to FIG. 18, the baffle 700 includes a plurality of walls 702 on the interior of the basket. Each of the walls generally extends radially from the outer wall of the basket towards the center of the basket. In some embodiments, the walls 702 meet in the central portion of the basket (see e.g., FIGS. 27 and 30); however, the present invention should not be considered so limited. For example, as shown in FIGS. 18-23, one or more of the walls 702 may not connect to the other walls 702. The walls 702 may be made of any suitable material, including materials similar or different from the material of the basket. The walls 702 may be generally solid, or may include one or more openings 706 (see e.g., FIG. 19) that generally permit water to flow through the walls, but substantially prevent coffee grounds from passing therethrough.

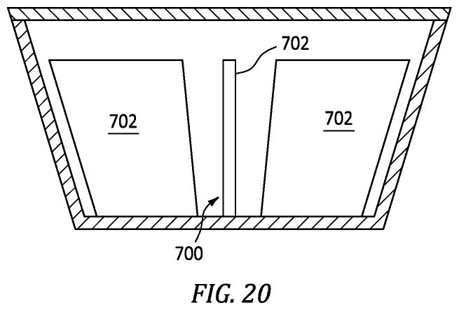

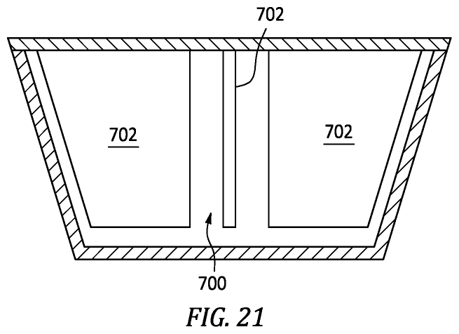

Referring now to FIGS. 18, 19, 22 and 23, one or more of the baffle 700 walls 702 are connected to the inner surface of the outer basket wall. Alternatively, as shown in FIGS. 20, 22 and 23, one or more of the baffle 700 walls 702 may be connected to the bottom wall of the basket and/or connected to the inner surface of the outer basket wall and the bottom wall of the basket. In a further alternative, and as shown in FIG. 21, one more or more of the baffle walls 702 of the baffle 700 may be connected to the lid of the basket.

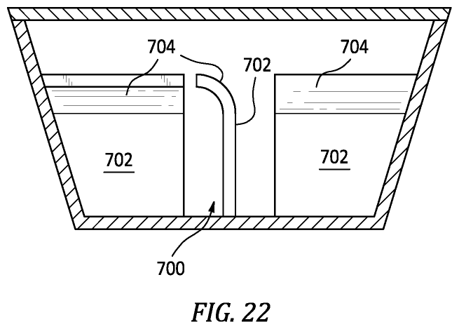

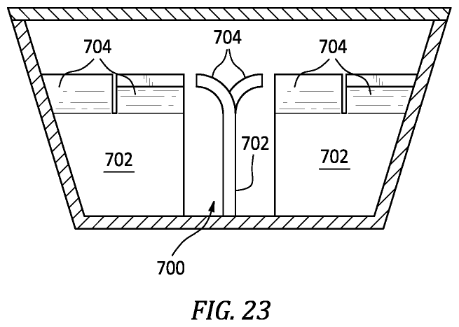

Referring now to FIGS. 22 and 23, one or more of the baffle 700 walls 702 may include one or more bends 704. In the embodiment shown, at least one baffle 700 wall 702 includes a bend 704. The bend 704 is intended, at least in part, to ensure contact between the coffee grounds and the baffle 700 wall 702 during operation. In some embodiments, the bend(s) 704 may also be designed to increase the agitation of the water that occurs inside the basket during the brewing process. In some embodiments, such as the one shown in FIG. 23, at least one of the baffle 700 walls 702 includes more than one bend 704. As shown, the upper portion of each of the walls 702 includes a bend 704 in a first direction and a second bend 704 in a second direction.

Disposable Basket

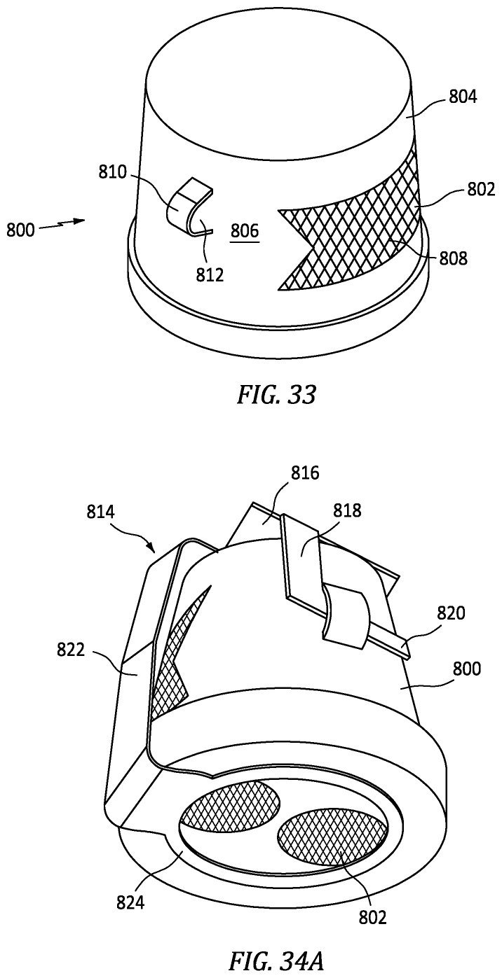

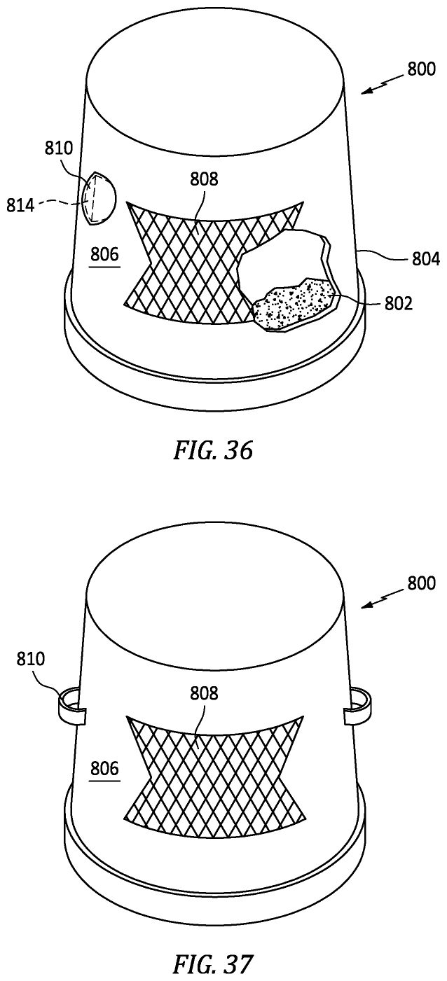

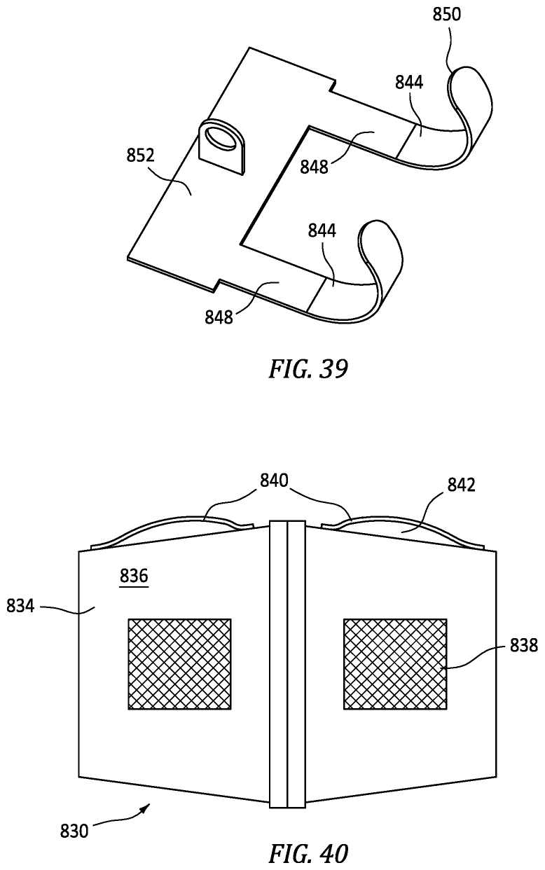

Referring now to FIGS. 33-41, in some embodiments where it is desirable to provide the end user with an easy-to-use solution, a disposable basket 800 may be utilized. Two examples are shown. The first example is displayed in FIGS. 33-38 and has been shown to have particular utility when used in connection with a machine that generally rotates and/or oscillates the disposable basket 800. The second example is shown in FIGS. 39-41 and has been shown to have particular utility when used in connection with a machine that generally linear manner (e.g., up and down).

Referring now to the first example shown in FIGS. 33-38, the basket 800 may be pre-filled with coffee grounds. Alternatively, the interior of the basket 800 may be accessible to the user (such as is shown in FIGS. 6, 11, 16A, and 17A-B). In the former example, the basket 800 would be marketed and sold as a pre-filled basket 800 that the user simply installs into a machine for brewing coffee. In the latter example, the basket 800 would arrive empty and the user would selectively access the interior of the basket 800 and add the ground coffee of their choice. The disposable basket provides certain advantages that the re-usable basket disclosed herein does not provide. For example, in examples where the disposable basket 800 is sold pre-filled with the ground coffee 802 already in the basket 800, the user does not need to grind, measure and/or add the beans 802 to the basket 800 prior to brewing each amount of coffee. In addition, as opposed to the pre-filled pouch, the disposable, pre-filled basket 800 can be inserted into the device or machine for brewing and then disposed of after the brewing process is complete without the need for an additional structural element into which the pouch would need to be positioned by the user. In examples where the basket 800 is filled by the user, the disposable basket 800 still has the advantage of ease of clean-up after the brewing process is complete.

Referring now to FIGS. 33 and 35-37, the disposable basket 800 includes a frame 804 that includes at least one outer wall 806. In a preferred embodiment, the basket 800 is generally barrel shaped; however, the present invention should not be considered so limited. For instance, the basket 800 can be, e.g., spherical, cubical, or ovoidal without departing from the spirit and scope of the present invention.

In similar fashion to the other embodiments described herein, the outer wall 806 of the basket 800 includes a plurality of openings 808 that generally permit water to ingress and egress the frame during a coffee brewing process while also substantially preventing the amount of coffee from exiting the frame during the brewing process. Interaction of liquid into and out of basket 800 can create a turbulent and agitated flow and movement of liquid. The turbulent and agitated flow and movement of liquid within basket 800 can permit enhanced liquid contact with solid ingredients (e.g., coffee grounds) within basket 800. The overall contact of liquid and solids/ingredient(s), for example, coffee, with the movement of liquid and solid ingredients, for example coffee, within basket 800 creates an infusion process during brewing where increased amounts of coffee oil is entrained in liquid.

Openings 808 may be formed in any shapes, pattern, or configurations including round holes, polygonal holes, slots, ellipsoids, and spirals, combinations thereof, or any configuration or pattern now known or hereinafter designed. The use of a mesh material is also acceptable. Moreover, openings 808 can be provided with irregularly shaped perimeters, which can increase turbulation and agitation of liquid, in the basket 800.

The frame 804 can be made of a single material or, alternatively, the frame made be from multiple different materials. For example, plastics and metals are known to be advantageous due to their manufacturability. Alternatively, in a preferred embodiment, the basket is constructed at least partially from bamboo due to its affordability, ease of manufacture, biodegradability and ability to withstand the coffee brewing environment. Preferably, materials are chosen that have structural stability such that the frame 804 is capable of substantially maintaining its original shape during the brewing process.

As with other embodiments disclosed herein, the disposable basket 800 may include a baffle as otherwise disclosed herein.

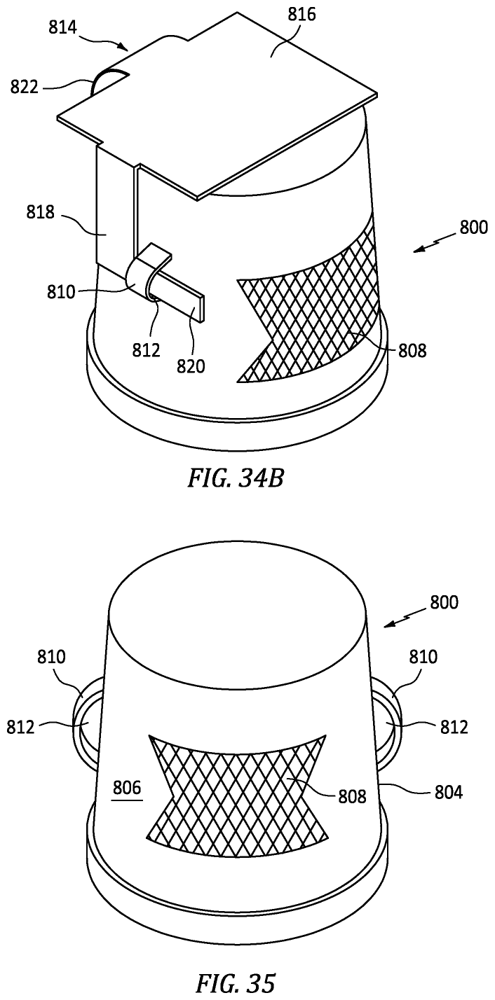

The basket 800 includes at least one point of connection 810 in order to enable it to be selectively attached to a complementary connector 814 on a coffee machine (see e.g., FIGS. 34A and 34B). In the embodiment shown, the basket 800 includes two points of connection or attachment 810. However, in some embodiments, the basket 800 includes, e.g., one point of attachment 810, three points of attachment 810, or more. In the embodiment shown in FIG. 33, the point of attachment 810 is located on the side of the basket 800 and includes an opening sized and shaped to receive a complementary connector 814 on the machine. The point of attachment 810 can include a through hole 812 where the complementary connector extends through (see FIG. 35). Alternatively, the point of attachment 810 can include an enclosed cavity 814 into which the complementary connector 814 is inserted but does not extend therethrough.

The basket 800 is agitated during normal brewing process. Therefore, it is important that the basket 800 is secured to the machine via the connector body 814 in a manner such that it does not detach during normal use. In some embodiments, the complementary connector 814 can be press fit into the point of attachment(s) 810 utilizing friction to maintain the connection. In other embodiments, the complementary connector 814 can be affixed via a positive connection (e.g., a latch) that prevents detachment during normal use. Preferably, the attachment provides an auditory cue (e.g., a “snap”) to notify the user of a satisfactory or completed connection during installation.

As shown in FIGS. 33-38, the direction of connection may be in a direction generally parallel to the surface of the water (i.e., the horizon). In other embodiments, the direction of connection may be generally perpendicular to the direction of the horizon (see e.g., FIG. 37) when the basket is in the brewing position. The actual direction of connection may be determined by the designer to ensure ease of use and to ensure the connection remains stable during normal use.

Referring now to the second example shown in FIGS. 39-41, the basket 830, in similar fashion to the basket 800 described in the first example above, may similarly be pre-filled with coffee grounds or, in the alternative, the interior of the basket 830 may be accessible to the user (such as is shown in FIGS. 6, 11, 16A, and 17A-B) and the user would add the grounds prior to brewing.

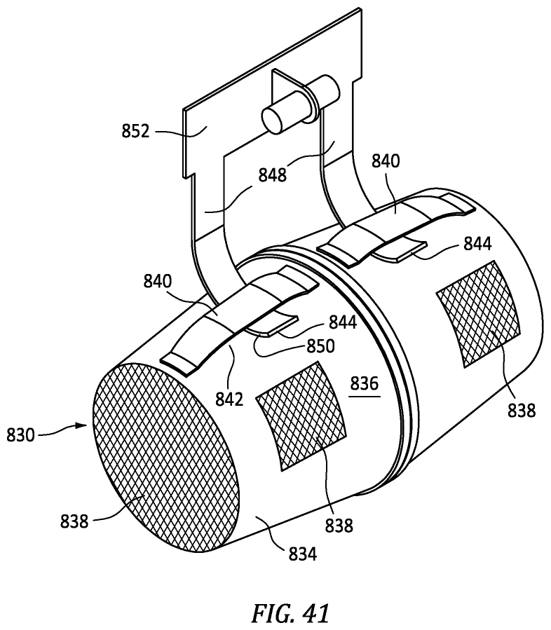

Referring now to FIGS. 40 and 41, the disposable basket 830 includes a frame 834 that includes at least one outer wall 836. In a preferred embodiment, the basket 830 is generally barrel shaped; however, the present invention should not be considered so limited. For instance, the basket 830 can be, e.g., spherical, cubical, or ovoidal without departing from the spirit and scope of the present invention.

In similar fashion to the other embodiments described herein, the outer wall 836 of the basket 830 includes a plurality of openings 838 that generally permit water to ingress and egress the frame during a coffee brewing process while also substantially preventing the amount of coffee from exiting the frame during the brewing process. Interaction of liquid into and out of basket 830 can create a turbulent and agitated flow and movement of liquid. The turbulent and agitated flow and movement of liquid within basket 830 can permit enhanced liquid contact with solid ingredients (e.g., coffee grounds) within basket 830. The overall contact of liquid and solids/ingredient(s), for example, coffee, with the movement of liquid and solid ingredients, for example coffee, within basket 830 creates an infusion process during brewing where increased amounts of coffee oil is entrained in liquid.

Openings 838 may be formed in any shapes, pattern, or configurations including round holes, polygonal holes, slots, ellipsoids, and spirals, combinations thereof, or any configuration or pattern now known or hereinafter designed. The use of a mesh material is also acceptable. Moreover, openings 808 can be provided with irregularly shaped perimeters, which can increase turbulation and agitation of liquid, in the basket 830.

The frame 834 can be made of a single material or, alternatively, the frame made be from multiple different materials. For example, plastics and metals are known to be advantageous due to their manufacturability. Alternatively, in a preferred embodiment, the basket is constructed at least partially from bamboo due to its affordability, ease of manufacture, biodegradability and ability to withstand the coffee brewing environment. Preferably, materials are chosen that have structural stability such that the frame 834 is capable of substantially maintaining its original shape during the brewing process.

As with other embodiments disclosed herein, the disposable basket 830 may include a baffle as otherwise disclosed herein.

The basket 830 includes at least one point of connection in order to enable it to be selectively attached to a complementary connector 834 on a coffee machine (see e.g., FIGS. 39 and 41). In the embodiment shown, the basket 830 includes two points of connection or attachment 840. However, in some embodiments, the basket 830 includes, e.g., one point of attachment 840, three points of attachment 840, or more. In the embodiment shown in FIG. 33, the point of attachment 840 is located on the side of the basket 830 and includes an opening sized and shaped to receive a complementary connector 844 on the machine. The point of attachment 840 can include a through hole 842 where the complementary connector extends through (see FIG. 39). Alternatively, the point of attachment 840 can include an enclosed cavity (similar to that shown in the first example of the basket 800) into which the complementary connector 844 is inserted but does not extend therethrough. As shown in FIG. 39, the version shown includes two points of attachment 840 located on the same side the basket 830 such that the points of attachment 840 are in line with and adjacent one another.

Similar to the first example, the basket 830 is agitated during normal brewing process. Therefore, it is important that the basket 830 is secured to the machine via the connector body 844 in a manner such that it does not detach during normal use. In some embodiments, the complementary connector 844 can be press fit into the point of attachment(s) 840 utilizing friction to maintain the connection. In other embodiments, the complementary connector 840 can be affixed via a positive connection (e.g., a latch) that prevents detachment during normal use. Preferably, the attachment provides an auditory cue (e.g., a “snap”) to notify the user of a satisfactory or completed connection during installation.

As shown in FIGS. 39-41, the direction of connection may be in a direction generally parallel to the surface of the water (i.e., the horizon). In other embodiments, the direction of connection may be generally perpendicular to the direction of the horizon when the basket is in the brewing position. The actual direction of connection may be determined by the designer to ensure ease of use and to ensure the connection remains stable during normal use.

Coffee Grounds

As described above, in a preferred embodiment, the coffee grounds are placed by the user directly in the basket prior to each operation. After each brewing operation, the coffee grounds are removed and discarded. However, in some embodiments, it may be preferable to use a pre-filled packet or (as described above) a pre-filled, disposable basket 800. For example, one advantage of a packet is that it enables pre-measurement of the grounds and minimal effort by the user during preparation for use.

An example of the packet that can be used with the first or second embodiment is shown in FIG. 8. The packet 2, 52 may have any shape, but preferably is shaped in a manner that is designed to fit into the basket such that the filter interacts with the wall(s) of the baffle during normal operation. In embodiments where a packet is utilized, it is critical that the packet 2, 52 be manufactured from a material that will permit water and the oil derived from the grounds to pass through the packet's material, but will not allow the grounds to escape the packet 2, 52. There are numerous types of materials that will allow water and oil to pass through but will keep the coffee grounds from escaping, and those of skill in the art will recognize such materials may be used to manufacture the packet 2, 52. In a preferred embodiment, the packet 2, 52 is comprised of material similar to or the same as the material that comprises coffee filters commonly used in the art. Suitable materials (some of which are currently used as coffee filters) include bleached paper, bamboo, nylon or even gold.

Installation of Disposable Basket

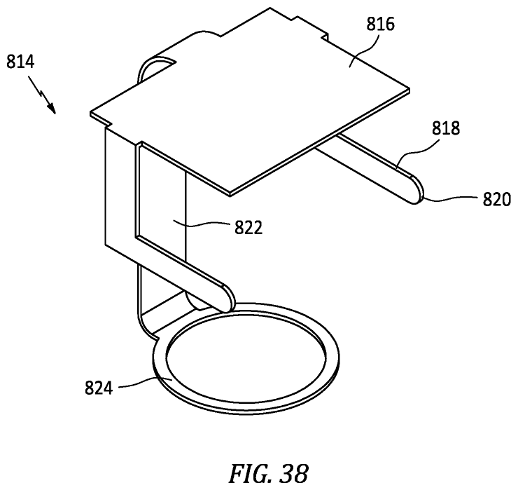

Referring now to FIGS. 34A, 34B and 38, the coffee brewing devices of any of the embodiments disclosed herein can be outfitted with a connector body 814 enabling a user to easily attach and detach a basket thereto. In some embodiments, the basket 800 may be a disposable basket as described herein.

As seen in FIG. 38, the connector body 814 includes an upper attachment element 816 that connects either directly or indirectly (e.g., via a rod) to the means for agitation. The connector body 814 includes at least one arm 818 having a distal end 820. The distal end 820 of the arm is preferably sized and shaped for insertion into the complementary attachment point 810 located on the basket 800. Although FIGS. 34A, 34B and 38 generally show two arms 818, the present invention is not so limited and the connector body 84 can include as few as one or more than two arms 818 without departing from the spirit and scope of the invention. As noted above with respect to the basket 800, the arms 818 are preferably sized and shaped such that they create an auditory cue (e.g., a “snap”) when a successful attachment to the basket has been achieved. The arms 818 can be shaped to achieve, e.g., a press fit into the complementary attachment point or a positive engagement (e.g., a latch).

The distal end 820 of the arm 818, as shown, is rounded to assist the user with guiding the arm 818 into the attachment point on the basket 800. However, the shape of the arm 818 can be any suitable shape. As shown the connector body 814 includes a central portion 822 that is intended to extend around at least a portion of at least one side of the basket and, optionally, can provide additional lateral support to the side of the basket 800 during the coffee brewing process. Additionally, a lower portion 824 of the connector body 814 may extend around a bottom of the basket 800 in order to generally provide vertical support during the agitation process that occurs during normal brewing.

The arm(s) 818 can extend from any portion of the connector body 814. As shown, the arms 818 generally extend from the upper attachment element 816; however, one more arms 818 could alternatively extend from the central portion 822 or lower portion 824 to achieve the same effect.

The connector body 814 should be constructed from a material that provides ample structural stability to retain the basket 800 during the agitation of the normal brewing process, as well as repeated installations and de-installations of a basket 800 before and after each brewing process. In addition, the material should be non-corrosive and should be stable in a coffee brewing environment that is likely acidic and subject to heat up to boiling or near boiling temperatures.

Referring back now to FIGS. 39-41, the coffee brewing devices of any of the embodiments disclosed herein can be outfitted with a connector body 844 enabling a user to easily attach and detach a basket thereto. In some embodiments, the basket 830 may be a disposable basket as described herein.

As seen in FIG. 38, the connector body 844 includes an upper attachment element 846 that connects either directly or indirectly (e.g., via a rod) to the means for agitation. The connector body 844 includes at least one arm 848 having a distal end 850. The distal end 850 of the arm is preferably sized and shaped for insertion into the complementary attachment point 840 located on the basket 830. Although FIGS. 39-41 generally show two arms 848, the present invention is not so limited and the connector body 844 can include as few as one or more than two arms 848 without departing from the spirit and scope of the invention. As noted above with respect to the basket 830, the arms 848 are preferably sized and shaped such that they create an auditory cue (e.g., a “snap”) when a successful attachment to the basket has been achieved. The arms 848 can be shaped to achieve, e.g., a press fit into the complementary attachment point or a positive engagement (e.g., a latch).

The distal end 850 of the arm 848, as shown, is rounded to assist the user with guiding the arm 848 into the attachment point on the basket 830. However, the shape of the arm 848 can be any suitable shape. As shown the connector body 844 includes a central portion 852 that is intended to provide vertical support to the arms 848 and the basket 830 during the coffee brewing process.

The connector body 844 should be constructed from a material that provides ample structural stability to retain the basket 830 during the agitation of the normal brewing process, as well as repeated installations and de-installations of a basket 830 before and after each brewing process. In addition, the material should be non-corrosive and should be stable in a coffee brewing environment that is likely acidic and subject to heat up to boiling or near boiling temperatures.

Agitation

With respect to the present invention generally, agitation is the process of churning or otherwise stirring the coffee grounds while water is extracting oil from the grounds. Examples of agitation rotating, oscillating, moving side-to-side, and bobbing up and down (or any combination thereof). While the present invention should not be so limited, it is preferable that the agitation in the present invention include at least a rotational aspect to the motion in order to fully utilize the benefits provided by the one or more baffle walls. By sufficiently agitating the grounds during the brewing process, all of the grounds (or at least a significant portion thereof) being used to brew a given batch of coffee have the opportunity to interact with the water. To achieve the greatest results using the infusion method of brewing coffee, the grounds should be agitated while the water gradually heats.

The present invention achieves agitation during the brewing process by automatic means that frees the user to perform other tasks while the coffee brews. The present invention does so in the first and second embodiments by agitating the basket 6, 56 within the water chamber 4 of the first embodiment or the carafe 54 of the second embodiment. The agitation takes place while the coffee grounds are within the basket 6, 56. There are numerous methods by which one of skill in the art may achieve agitation of the basket 6, 56, and all such methods should be considered within the scope of the present invention.

In the first embodiment, the present invention achieves agitation as follows: (i) a means for agitating the water in the form of a motor 24 is installed generally above the water chamber 4; (ii) the water chamber 4 is filled with water; (iii) the basket 6 is attached to the motor via a universal joint 20; (iv) once the motor 24 is activated, this causes the basket 6 mechanically attached to the motor to rotate around an axis; (v) the rotating of the basket 6 and the baffle 700 walls 702 through the water, which is being gradually heated as further described below, causes the coffee grounds within the basket 6 to churn while fully immersed in the gradually heating water, thereby achieving the desired agitation.

In the second embodiment, shown in FIG. 12, the present invention achieves agitation as follows: (i) a motor 64 is affixed to the carafe's lid 60; (ii) the carafe 54 is filled with water (ideally such that the grounds are fully submerged); (iii) the basket 56 is connected to the motor 64; (iv) once the motor 64 is activated, this causes the basket 56 and the baffle 700 walls 702 in the basket 56 connected to the motor 64 to rotate; (v) the rotating (shown by the arrowed indicated by reference number 66) of the basket 56 through the water, which is being gradually heated from tap temperature to approximately boiling, causes the coffee grounds within the basket 56 to churn while fully immersed in the gradually heating water, thereby achieving agitation.

In a preferred embodiment of the invention shown in several FIGS (including FIG. 12), the basket 56 is connected to the motor 64 via an elongated member 68 (e.g., a shaft). The basket 56 is affixed to the bottom end of the member 68 and the top end of the member 68 is affixed to the motor 64. When the motor 64 is activated, the motor 64 causes the elongated member 68 to rotate (see arrow showing rotation indicated by Reference Number 66), which in turn causes the basket 56 (and the baffle 700 walls 702 therein) affixed to the elongated member 68 to rotate. When the basket 56 spins with the carafe 54 full of heating water and the coffee grounds contained therein, agitated infusion is achieved. However, those with skill in the art will recognize that there are additional methods by which the basket 56 may be connected to a motor 64 such that when the motor 64 is activated agitation is achieved and all such methods should be considered within the scope of the present invention.

Heating Components and Application of Heat

As explained further herein, the water within the water chamber 4 of the first embodiment or the carafe 54 of the second embodiment must be heated from an initial temperature (e.g., tap temperature) to a second temperature that is optimal for brewing coffee. The second temperature is optionally approximately that at which water boils but is most preferably in the between 190 degrees F. and 210 degrees F. However, the heating process preferably occurs relatively quickly because users generally are not willing to wait longer than 6-8 minutes for coffee to brew. If a brewing system takes longer than 6-8 minutes to brew the coffee, many users will opt for a system that brews coffee more quickly.

Referring to the first embodiment, there are numerous methods by which a person with skill in the art can cause the water within the water chamber 4 to heat, and all such methods should be considered within the scope of the present invention. In a preferred embodiment shown in FIG. 7, the present invention includes copper coiling 26 that is in contact with the water chamber 4. In FIG. 7, the copper coiling 26 (or other heat source) is in contact with the bottom of the water chamber 4, but the copper coiling may be in contact with any portion of the water chamber 4, so long as the placement of the copper coiling 26 (or other heat source) does not interfere with the present system's operation (for example, the copper coiling may be placed in contact with the sides of the water chamber).

The process of using copper coils to conduct heat is well known in the art. In short, electricity passes through the copper coils, causing them to heat, and the heat of the copper coils is then transferred to the water chamber as a result of the coils contacting the chamber's exterior. Once the chamber itself begins to heat, the heat transfers from chamber to the water stored therein. In a preferred embodiment of the present invention, 1200-1500 watts of electricity should be used to heat the water chamber, as this amount energy will gradually heat the water in the chamber from tap temperature to approximately boiling within the 6-8 minutes time frame in which coffee should be brewed.

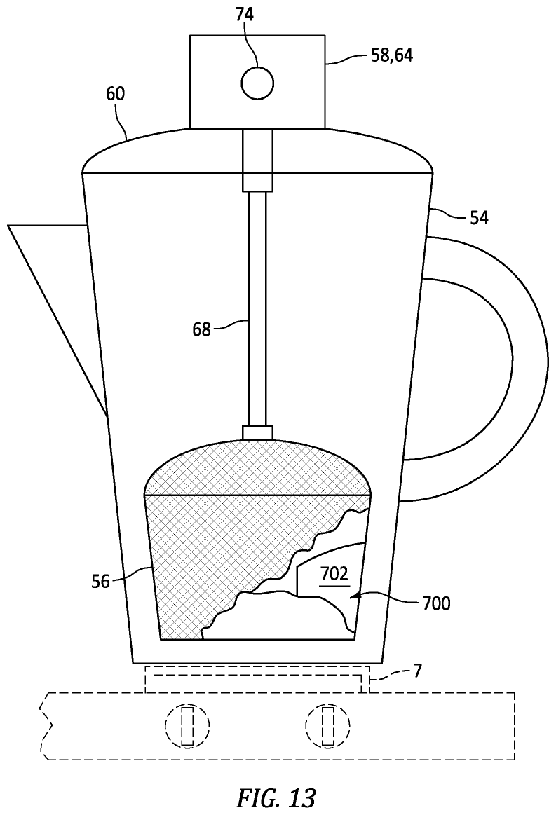

With respect to the second embodiment, there are numerous methods by which a person with skill in the art can cause the water within the carafe 54 to heat to the second temperature at which it is desirable to brew coffee, and all such methods should be considered within the scope of the present invention. The present invention may include an element for heating or may rely on external heat sources. In an embodiment shown in FIG. 13, the present invention does not include any heating element and relies on an external heat sources 70, such as the heat generated by a user's stove. When using this embodiment of the present invention, the user places the carafe 1 on a stove burner 70 (or other heat source) and adjusts the heat from a stove burner 70 (or other heat source) such that the heat will be sufficient to raise the temperature of the water from tap temperature to approximately boiling and more preferably to between 190 degrees F. and 210 degrees F.

The apparatus may include a means for monitoring the temperature of the water and alerting the user when the user should reduce or cease applying heat to the apparatus. One such means includes using a thermometer, similar to a meat thermometer or other thermometers, that monitors the heat of the water within the carafe and displays the temperature on the outside of the apparatus. If a thermometer is used, the user must vigilantly monitor the thermometer; possess the knowledge regarding when heat should be removed or reduce; and reduce or remove the heat accordingly.

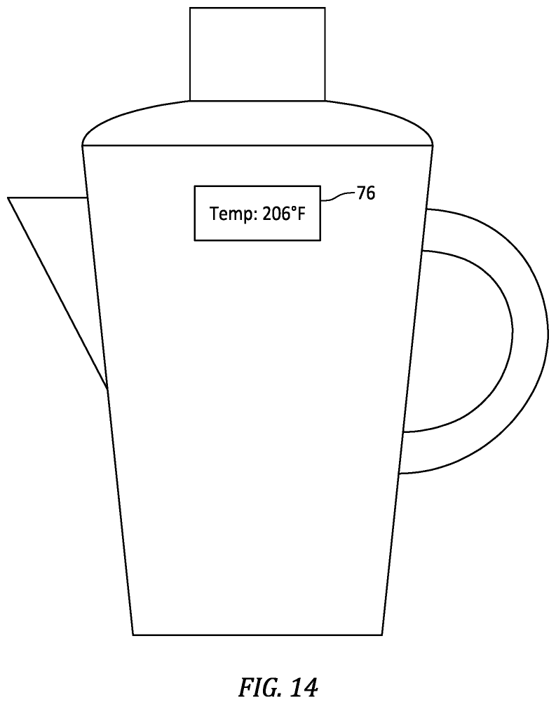

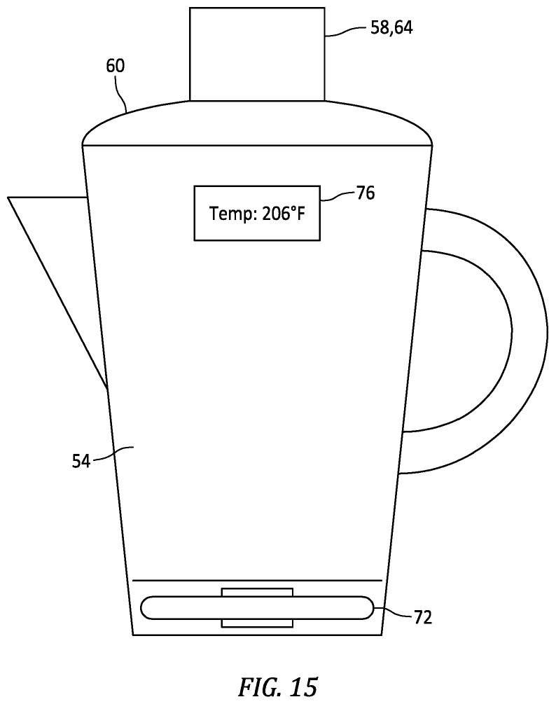

Other embodiments of the present invention may include electronic means for monitoring the temperature of the water and alerting the user when the user should reduce or cease applying heat to the apparatus (for an example, see Reference Number 76 at FIGS. 14 and 15). There are numerous electronic means that may be used to monitor the temperature of the water within the apparatus that are well known in the art, and all such means are included within the scope of the present invention. Two of the many examples of such well known electronic means include: (i) an electronic interface that is able to receive input from the elements of the apparatus and relay to the user via display, audible alerts, etc, that the heat should be reduced or removed; and (ii) a standard circuit board with electrical wiring to the elements of the apparatus, where such wiring is able to receive input such as temperature readings of the water within the carafe and alert the user that heat should be reduced or removed.

As noted above, other embodiments may include a means for heating liquid that may be present within the carafe 54. There are numerous methods by which a person with skill in the art can cause the water within the carafe to heat, and all such methods should be considered within the scope of the present invention. In a preferred embodiment shown in FIG. 15, the present invention includes copper coiling 72 that is in contact with the carafe 54. In FIG. 15, the copper coiling 72 is in contact with the bottom of the carafe 54, but the copper coiling 72 may be in contact with any portion of the carafe 54, so long as the placement of the copper coiling 72 does not interfere with the present system's operation or pose a danger for users (for example, the copper coiling 72 may be placed in contact with the sides of the carafe 54).

The process of using copper coils 72 to conduct heat is well known in the art. In short, electricity passes through the copper coils 72, causing them to heat, and the heat of the copper coils 72 is then transferred to the carafe 54 as a result of the coils contacting the carafe's 54 exterior. Once the carafe 54 itself begins to heat, the heat transfers from carafe 54 to the water stored therein. In a preferred embodiment of the present invention, 1200-1500 watts of electricity should be used to heat the carafe 54, as this amount of energy will gradually heat the water in the carafe 54 from tap temperature to approximately boiling (and preferably to between 190 degrees F. and 210 degrees F.) within the 6-8 minutes time frame in which coffee should be brewed.

In any embodiment of the present invention, the carafe may include material that will prevent a user from touching a portion of the carafe that has become hot once heat is applied. There are numerous methods of prohibiting users from burning themselves by touching hot portions of the carafe and all such means should be included within the scope of the present invention. One such means includes covering portions of the carafe in materials that do not conduct heat (or that conduct heat very poorly). There are numerous polymers that are able to withstand heat but not conduct heat well, and such polymers may be used to cover portions of the carafe to prevent user burns. Another means to prevent user burns includes fabricating the handle of the carafe from material that does not conduct heat.

Activating the Means for Agitation

If the embodiment of the invention that the user is using relies on external heat, then the means for agitating the basket must be activated upon the application of such external heat. For example, with respect to the second embodiment (shown in FIG. 13), the means for agitation 58 may be activated manually, such as by pressing a button or a switch 74. In addition, the means for agitation may be activated by the application of such external heat. Those with skill in the art will recognize that there are numerous means for adapting the means for agitation such that the application of external heat will activate the means for agitating the basket and all such numerous means should be considered within the scope of the present invention for all embodiments. One such means for activating the agitation means upon the application of heat includes electronic means. As described above, the present invention may include an electronic interface that is able to receive input from the elements of the apparatus. Such electronic interface may also be configured to send signals to elements of the apparatus based on the input that it has received from other elements of the apparatus. Thus, the electronic interface may receive input that heat is being applied to the water within the water chamber 4 (first embodiment) or the carafe 54 (second embodiment) and may then send a signal that activates the means for agitating the basket 6, 56.

If the embodiment of the present invention includes means for heating the water within the carafe, such as the copper coiling shown in FIG. 15 of the second embodiment, and described above, then the means for agitating the basket may be activated upon the activation of the apparatus' means for heating the water. Those of skill in the art will recognize how the means for agitating the basket may be adapted to activate upon the activating of the means for heating the water within the carafe or water chamber.

Alternatively, even if the embodiment of the present invention includes a means for heating the water within the carafe, the means for agitating the basket may be activated separately from the means for heating the water. For example, the means for agitating the basket may be activated by a standalone button or switch that must be pressed independently of activating the means for heating the water within the carafe.

### Third Embodiment

Referring now to FIGS. 24-27, a third embodiment of the present invention is shown and described herein. In similar fashion to the first three embodiments of the present invention, the third embodiment also provides an apparatus and method for brewing coffee and other beverages, such as tea, that employs an infusion process and liquid agitation, which extracts enhanced amounts of oil from coffee beans, coffee grounds, filter packs of coffee, tea, and the like to produce a brewed coffee of the highest quality and taste. The process, also in similar fashion to the first three embodiments, preferably takes place at temperatures between 180 degrees F. and 200 degrees F., and most preferably at approximately 198 degrees F. The apparatus 400 of the present embodiment is intended to be used with a pre-existing vessel 402 as shown, for example, in FIG. 24.

The pre-existing vessel 402 can be any suitable vessel that has a suitable cavity 404 therein for brewing, storing and/or dispensing liquid. The size of the vessel only matters in as much as the pre-existing vessel 402 should be large enough to hold the desired amount of liquid beverage. For example, the pre-existing vessel 402, as shown in FIG. 24, is a large urn that is commonly used to dispense relatively large amounts of coffee (e.g., more than 100 cups of coffee) at events such as weddings or professional conferences. Alternatively, the pre-existing vessel 402 could be much smaller in size, such as a single serve coffee mug that holds approximately 12 fluid ounces of liquid. Preferably, the pre-existing vessel 402 is water tight and is made of a suitable material that does not react in the presence of hot liquids. In addition, it is preferable that the pre-existing vessel 402 has insulated walls in order to assist in achieving and maintaining the desired brewing and/or drinking temperature, as well as to prevent rapid heat loss from the liquid after brewing. In some cases, the pre-existing vessel 402 may include a spout (similar to that shown in FIG. 12) where the brewed coffee may be poured from the vessel. In other cases, the pre-existing vessel, as shown in FIG. 24, may include a dispenser port where users can selectively dispense a desired amount of the brewed beverage from the pre-existing vessel 402.

In some cases, the pre-existing vessel 402 may include a heat source (not shown) capable of raising and/or maintaining the temperature of the liquid (e.g., water, coffee) stored in the cavity. In many instances the heat source is electrical and powered via either an alternating-current (AC) electric power supply or a battery. However, the present invention should not be considered to be so limited. Generally speaking, most pre-existing vessels 402 that have a heat source have user accessible controls that enable the user to select the desired temperature of the liquid contained in the pre-existing vessel 402.

The pre-existing vessel 402 may optionally include a lid that is, preferably, removable (or at least, e.g., hinged such that the lid is partially removable) so that the apparatus 400 can be installed/uninstalled during the brewing process. After the brewing process, it may be desirable to re-apply the lid in order to maintain the temperature of the beverage. In some instances, as is shown in FIG. 24, the apparatus 400 can be designed to replace the original lid of the pre-existing vessel 402.

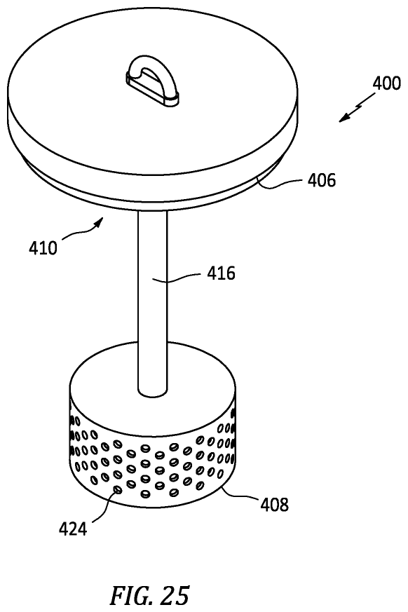

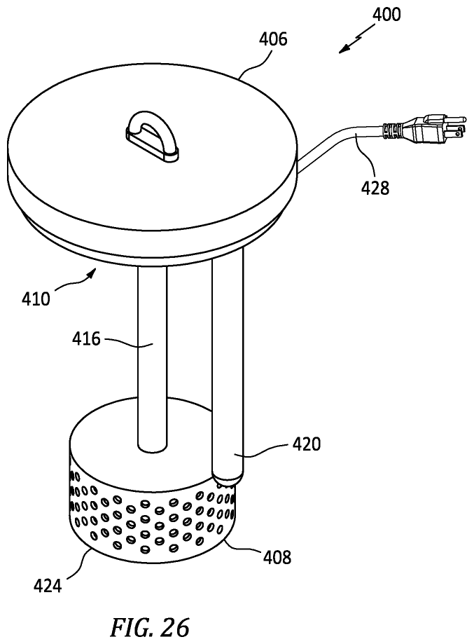

Referring now to FIGS. 25-27, the apparatus 400 is shown and includes a frame 406, a basket 408, a means for agitating 410 the basket 408, and a power source 413. The means for agitating 410 the basket 408 includes a motor 414, a linkage 416, and a controller 418. The apparatus may optionally include a heat source 420, as shown in FIG. 26.

The frame 406 of the apparatus generally provides structural support for the various components during use. In addition, the frame 406 positions the various components (e.g., basket 408 and means for agitating 410 the basket 408) in the appropriate position for normal operation. The frame 406 may take on various forms and shapes depending on the desire of the end user. For example, as shown in FIGS. 24 and 25, the frame 406 may rest on the lip 422 of the opening to the cavity 404 of the pre-existing vessel 402. However, in other embodiments, the frame 406 may include a stand so that the apparatus sits on a surface (e.g., a countertop), such as is utilized in the first embodiment of the present invention and shown FIG. 1. The frame 406, in some instances, can be designed such that it floats in the liquid during the brewing process. Alternatively, the frame 406 may be hung above the pre-existing vessel 402 such that the basket 408 extends downward into the pre-existing vessel 402. The above are considered non-limiting examples of manners in which the frame 406 can be configured.

Similar to the first and second embodiments, the present third embodiment also utilizes a basket 408. The basket 408 includes a baffle 700 as described above and shown in FIGS. 18-23. The basket 408 may include a multitude of ports, holes, orifices, or openings, referred to as openings 424. Movement of basket 408 permits liquid to transgress into and out of openings 424. Interaction of liquid into and out of basket can create a turbulent and agitated flow and movement of liquid. The turbulent and agitated flow and movement of liquid can be within pre-existing vessel 402 and also can be within basket 408. The turbulent and agitated flow and movement of liquid within basket 408 can permit enhanced liquid contact with solid ingredients (e.g., coffee grounds) within basket 408. The overall contact of liquid and solids/ingredient(s), for example, coffee, with the movement of liquid and solid ingredients, for example coffee, within basket creates an infusion process during brewing where increased amounts of coffee oil is entrained in liquid.

Openings 424 allow liquid to enter and exit while limiting the exit of solid ingredients, if coffee or solids are disposed in basket 408. Openings 424 may be formed in any shapes, pattern, or configurations including round holes, polygonal holes, slots, ellipsoids, and spirals, combinations thereof, or any configuration or pattern now known or hereinafter designed. Moreover, openings 424 can be provided with irregularly shaped perimeters, which can increase turbulation and agitation of liquid, both in pre-existing vessel 402 and in basket 408.

In similar fashion to the embodiments discussed above, coffee grounds may be placed directly into the basket or may be placed within the basket 408 inside a packet 426 (see e.g., FIG. 8). The basket 408, as discussed in further detail infra., may be permanently connected to the linkage 416, or removably connected to the linkage 416. In addition, in embodiments where the basket 408 is removably attachable to the linkage 416, the basket 408 may either be reusable (i.e., re-filled with ground coffee or a new packet 426) or intended to be discarded after a single use and replaced with a substantially similar replaceable item.

The apparatus 400 includes means for agitating 410 the basket 408. The means 410 includes at least one motor 414 that is connected to the frame 406, and a linkage 416 that transfers motion of the motor 414 to the basket 408. Various types of basket 408 motion have been described in the present application, and each can be utilized in the present embodiment. For example, the means for agitating basket 10 can, for example, impart any of the following types of motions: rotational, up and down (i.e., bobbing), and/or oscillating. With respect to rotational and oscillating motion, the basket 408 can generally be turned in a single direction (e.g., clockwise) throughout the brewing process, or the basket 408 can be turned alternately in generally opposite directions (e.g., clockwise, then counter-clockwise) during the brewing process. In addition, a combination of motions can be utilized (e.g., up and down and rotating). One of skill in the art would also understand that the present invention is not limited by the above types of motion and includes any additional types of motion (e.g., randomized) that has the effect of agitating the basket.

In some instances, and now referring to FIG. 26, the apparatus 400 may include an on-board heat source 420. In instances where the on-board heat source 420 is present, the on-board heat source 420 can be used as the primary method of heating and maintaining the temperature of the liquid in the pre-existing vessel 402. Alternatively, the on-board heat source 420 can be used in combination with the heat source on the pre-existing vessel 402.

The apparatus 400 further includes a controller 418. Preferably, the controller 418 is programmed to perform one or more of the following tasks: receive user inputs, monitor the temperature of the liquid in the pre-existing vessel 402, control the operation of the means for agitating 410 the basket 408, and cease the operation of the apparatus 400 once the brewing process is complete. User operated inputs to the apparatus 400 can be achieved in any known manner. For example, user inputs are possible via manual levers or LCD touchscreens.

In order to power the means for agitating 410 the basket 408, and the optional heat source 420, at least one of an alternating-current (AC) electric power supply 428 or a battery power 430 source (as shown in FIG. 27) is required. Various factors, such as portability, overall power needs for operation of the apparatus, and cost will dictate whether a battery 430 power or AC power 428 supply is utilized.

Cold Brew Option

Referring now to FIGS. 28-32, two versions of a fourth embodiment of the present invention is shown and described herein. While embodiments one, two, and three utilized the addition of heat and agitation to the brewing process, the apparatus 500 of the present fourth embodiment relates to enabling a user to brew coffee at or below room temperature. The process is commonly referred to as cold brewing coffee. Therefore, a heat source is an unnecessary component of apparatus 500. The addition of agitation using similar means to those described above with respect to embodiments one, two, and three have been found to be particularly advantageous. The agitation has been found to reduce the time required to cold brew coffee (and other beverages), as well as reduce the amount of the coffee grounds (or other solids) as compared to brewing a similar beverage without agitation.

Referring now to FIGS. 28-32, the apparatus 500 is shown and includes a vessel 502, an optional valve 504, an optional second vessel 506, a frame 507, a basket 508, a means for agitating 510 the basket 508, and a power source 512. The means for agitating 510 the basket 508 includes a motor 514, a linkage 516, and a controller 518. The basket 508 includes a baffle 700 as described above and shown in FIGS. 18-23.

The vessel 502 can be any suitable vessel that has a suitable cavity 522 therein for brewing, storing and/or dispensing liquid. The size of the vessel 502 only matters in as much as the vessel 502 should have a cavity 522 large enough to hold the desired amount of liquid beverage therein. For example, the vessel 502, as shown in, e.g., FIG. 28, is a sized to hold approximately 6 cups of coffee; however, larger or smaller vessels 502 can be utilized without departing from the spirit and scope of the present invention.

Preferably, the vessel 502 is watertight and is made of a suitable material that does not react in the presence of hot or cold liquids. In addition, it is preferable that the vessel 502 has insulated walls in order to maintain the desired temperature. In some cases, the vessel 502 may include a spout (similar to that shown in FIG. 12) where the brewed beverage may be poured from the vessel 502.

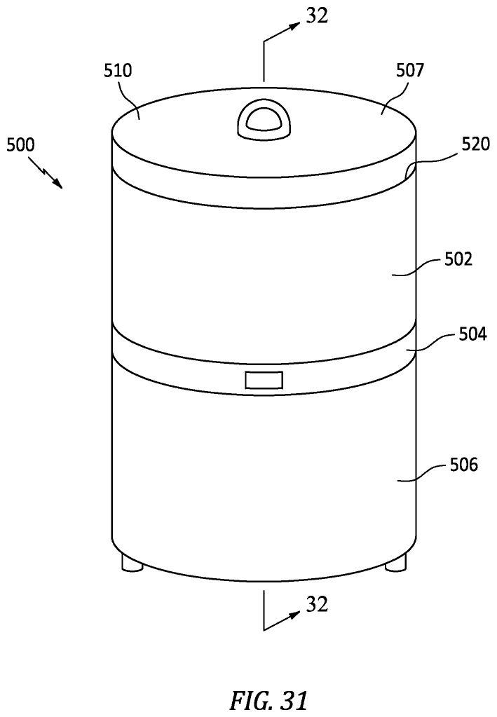

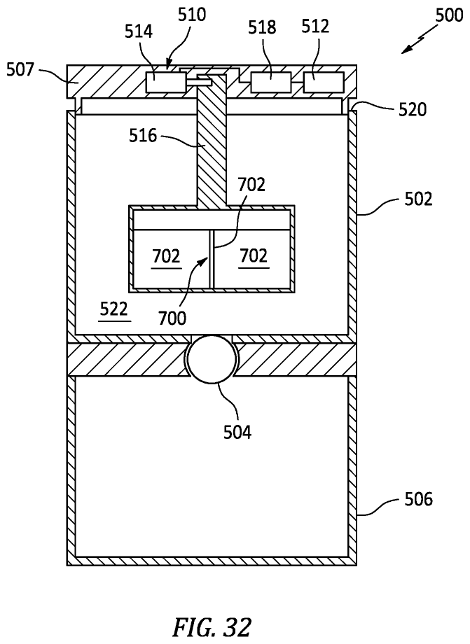

In other instances, as is shown in FIGS. 31-32, the vessel 502 may be fitted with a user-operable valve 504 that enables the brewed beverage to be dispensed into a second vessel 506. The second vessel 506 may be intended for either drinking the brewed beverage therefrom. Alternatively, the second vessel 506 may be intended for storing and/or dispensing the brewed beverage therefrom. Generally speaking, the brewed beverage flows through the valve 504 that is selectively opened by the user and is gravity fed into the second vessel 506. The second vessel 506 may have a lid (not shown) for storage of the brewed beverage.

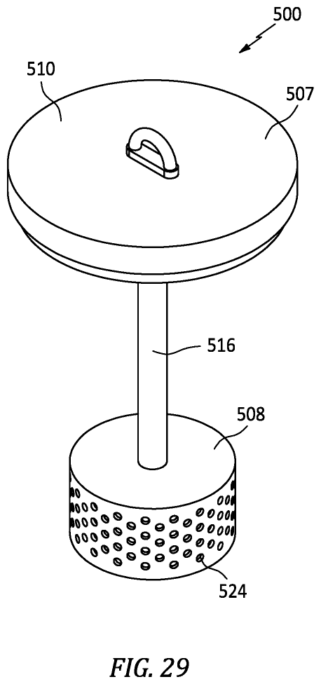

Referring now to FIGS. 29, 30, and 32, the frame 507 of the apparatus generally provides structural support for the means for agitation 510. In addition, the frame 507 positions the various components (e.g., basket 508 and means for agitating 510 the basket 508) in the appropriate position for normal operation.

The frame 507 may take on various forms and shapes depending on the desire of the end user. In preferred instances, as shown in FIGS. 28-31, the frame 507 may rest on the lip 521 of the opening to the cavity 522 of the vessel 502. However, the above set-up is considered a non-limiting example of manners in which the frame 507 can be configured relative to the vessel 502 during normal use.

Similar to the first, second, and third embodiments, the present fourth embodiment also utilizes a basket 508. The basket 508 may include a multitude of ports, holes, orifices, or openings, referred to as openings 524. Movement of basket 508 permits liquid to transgress into and out of openings 524. Interaction of liquid into and out of basket 508 can create a turbulent and agitated flow and movement of liquid. The turbulent and agitated flow and movement of liquid can be within vessel 502 and also can be within basket 508. The turbulent and agitated flow and movement of liquid within basket 508 can permit enhanced liquid contact with solid ingredients within basket 508. The overall contact of liquid and solids/ingredient(s), for example, coffee, with the movement of liquid and solid ingredients, for example coffee, within basket creates an infusion process during brewing where increased amounts of coffee oil is entrained in liquid.

Openings 524 allow liquid to enter and exit while limiting the exit of solid ingredients, if coffee or solids are disposed in basket 508. Openings 524 may be formed in any shapes, pattern, or configurations including round holes, polygonal holes, slots, ellipsoids, and spirals, combinations thereof, or any configuration or pattern now known or hereinafter designed. Moreover, openings 524 can be provided with irregularly shaped perimeters, which can increase turbulation and agitation of liquid, both in vessel 502 and in basket 508.

Coffee grounds may be placed directly into the basket 508 or may be placed within the basket 508 inside a packet 526 (see e.g., FIG. 8). The basket 508, as discussed in further detail infra., may be permanently connected to the linkage 516, or removably connected to the linkage 516. In addition, in embodiments where the basket 508 is removably attachable to the linkage 516, the basket 508 may either be reusable (i.e., re-filled with ground coffee or a new packet 526) or intended to be discarded after a single use and replaced with a substantially similar replaceable item.

The apparatus 500 includes means for agitating 509 the basket 508. The means 509 includes at least one motor 514 that is connected to the frame 507, and a linkage 516 that transfers motion of the motor 514 to the basket 508. Various types of basket 508 motion have been described in the present application, and each can be utilized in the present embodiment. For example, the means for agitating 509 the basket 508 can, for example, impart any of the following types of motions: rotational, up and down (i.e., bobbing), and/or oscillating. With respect to rotational and oscillating motion, the basket 408 can generally be turned in a single direction (e.g., clockwise) throughout the brewing process, or the basket 408 can be turned alternately in generally opposite directions (e.g., clockwise, then counter-clockwise) during the brewing process. In addition, a combination of motions can be utilized (e.g., up and down and rotating). One of skill in the art would also understand that the present invention is not limited by the above types of motion and includes any additional types of motion (e.g., randomized) that has the effect of agitating the basket 508. The baffle 700 ensures that the water in the basket 508 is sufficiently agitated and that the coffee grounds do not remain stationary inside the basket 508 during operation.

The apparatus 500 further includes a controller 518. Preferably, the controller 518 is programmed to perform one or more of the following tasks: receive user inputs, control the operation of the means for agitating 509 the basket 508, and cease the operation of the apparatus 500 once the brewing process is complete. User operated inputs to the apparatus 500 can be achieved in any known manner. For example, user inputs are possible via manual levers or LCD touchscreens.

In order to power the means for agitating 509 the basket 508 at least one of a battery power source 528 (as shown in, e.g., FIGS. 30 and 32) or an alternating-current (AC) electric power supply (not shown) is required. However, due to the likelihood that the apparatus 500 will be at least partially operated inside a refrigerator, it is highly likely that a battery power source 528 will be utilized.

The Brewing Process

The process for brewing coffee that is implemented using the present invention has already been described in part above with respect to the three embodiments, but for completeness is set forth herein in total for each.

The brewing process for the apparatus of the first embodiment includes the following steps:
1) The user accesses the basket 6 and places a packet 2 of coffee grounds therein. Alternatively, the user may purchase a packet that is pre-loaded with coffee grounds. Alternatively, the user attaches a disposable basket to the connector body by attaching at least one connector arm to the point of attachment on the basket (see e.g., FIGS. 33-41).
2) The user manually adds water to the water chamber 4. This may be done by opening the apparatus to access the water chamber 4, opening the water chamber 4, and pouring water therein (the user could add water to the chamber before placing the packet into the basket; the order of these two steps is within the user's discretion). Ideally, the amount of water added to the carafe should result in the basket being fully submerged (though this amount of water is not strictly required).
3) Once the packet 2 is placed in the basket 6 or the basket is successfully loaded onto the connector body, water is added to the water chamber 3, and the basket 6 and water chamber 4 are “closed”, then the user may initiate the brewing cycle.
4) The apparatus includes a button (or equivalent means), which upon being pressed by a user will initiate the brewing process.
5) When the brewing process begins, the heating means 8 will begin to heat the water within the water chamber 4 from tap temperature toward the approximately boiling temperature. Alternatively, the user may elect to “pre-heat” water to any desirable temperature between tap water temperature and near boiling (preferably between 190 degrees F. and 210 degrees F.). In the instance the user adds pre-heated water, the system will either heat the water the remainder of the amount necessary to achieve the desired brewing temperature, or will simply maintain the temperature of the water if the water added is already within the desired range.
6) At or about the time the heating means begins to heat the water, the agitating means begins to agitate the coffee grounds within the gradually heating water. The baffle in the basket ensures that the water in the basket is sufficiently agitated and that the coffee grounds do not remain stationary inside the basket during operation.
7) Over the course of 6-8 minutes, the heating means raises the temperature of the water from tap temperature (or another temperature at which water is liquid, but tap temperature is preferred) to approximately boiling and the agitation process occurs throughout the time that the water is heating.
8) Once the heating means has raised the water temperature to approximately boiling (and preferably between 190 degrees F. and 210 degrees F.), the heating stops (as discussed below, the heating of the water may be controlled by electronic means) increasing the temperature of the water and, optionally, is adjusted in order to provide an amount of heat necessary to maintain the temperature of the water during brewing within the desired range. At this point, agitation may optionally continue for an additional 30 seconds to one (1) minute.
9) The brewed coffee that has now been created by the heating of the water and agitation of the packet of coffee grounds is now released from the chamber into a storage receptacle situated below the chamber.
10) The apparatus may include means for keeping warm the brewed coffee in the storage receptacle until a user drinks the coffee.
11) The user removes the coffee grounds or the disposable basket from the connector body and disposes of the spent product.

The brewing process for the apparatus of the second embodiment includes the following steps:
1) The user accesses the basket 56 and places a packet 52 of coffee grounds therein. Alternatively, the user may purchase a packet or a disposable basket that is pre-loaded with coffee grounds.
2) The user manually adds water to the carafe 54. Ideally, the amount of water added to the carafe should result in the basket being fully submerged (though this amount of water is not strictly required).
3) If the embodiment of the invention that the user is using relies on external heat, the user then applies such external heat. If the embodiment of the invention that the user is using includes a means for heating the water within the carafe, the user activates the means for heating the water.
4) At or about the time the water begins to heat, the agitating means begins to agitate the coffee grounds within the gradually heating water. The baffle ensures that the water in the basket is sufficiently agitated and that the coffee grounds do not remain stationary inside the basket during operation.
5) Over the course of 6-8 minutes, the heating means raises the temperature of the water from tap temperature (or another temperature at which water is liquid, but tap temperature is preferred) to approximately boiling and the agitation process occurs throughout the time that the water is heating. Alternatively, the user may elect to “pre-heat” water to any desirable temperature between tap water temperature and near boiling (preferably between 190 degrees F. and 210 degrees F.). In the instance the user adds pre-heated water, the system will either heat the water the remainder of the amount necessary to achieve the desired brewing temperature, or will simply maintain the temperature of the water if the water added is already within the desired range.
6) Once the heating means has raised the water temperature to approximately boiling (and preferably between 190 degrees F. and 210 degrees F.), the heating stops (as discussed herein, the heating of the water may be controlled by electronic means or manually) increasing the temperature of the water and, optionally, is adjusted in order to provide an amount of heat necessary to maintain the temperature of the water during brewing within the desired range. At this point, agitation may continue for an additional 30 seconds to one (1) minute.
7) The brewed coffee that has now been created by the heating of the water and agitation of the packet of coffee grounds may now be poured from the carafe and enjoyed by the user.
8) The user removes the coffee grounds or the disposable basket from the connector body and disposes of the spent product.

If the embodiment of the present invention includes a means for heating the water within the carafe, then the means for heating the water may also keep the coffee warm once the brewing process has completed.

In addition, in embodiments of the invention that include a means for heating the water within the carafe, both the apparatus and the method may be controlled by automated, electronic means. The electronic control means enables a user to vary the settings of the apparatus and how it employs the method in order to brew coffee to suit the user's preference. For example, a user could use the electronic control means to program the apparatus to agitate the grounds for less time during the brewing cycle, resulting in a less robust coffee. Electronic control means allows the entire brewing cycle to run from start to finish without additional action by the user once the user has added coffee and water to the system and has used the electronic control means to configure the brew cycle to suit the user's preference and then has pressed the start button (or similar means for initiating the brewing cycle). There are numerous electronic control means that may be used to control the apparatus and method that are well known in the art, and all such means are included within the scope of the present invention. As noted above, two of the many examples of such well known electronic control means include: (i) an electronic interface that is able to send instructions to and receive input from the elements of the apparatus, thereby enabling the interface to control each element; and (ii) a standard circuit board with electrical wiring to the elements of the apparatus, where such wiring is able to send instructions to and receive input from each element.

The brewing process for the apparatus of the third embodiment includes the following steps:
1) A first solid ingredient (e.g., coffee) is added to the basket 408. Basket 408 is affixed to the linkage 416 and the apparatus 400 is positioned relative to the pre-existing vessel 402 such that the basket 408 is located within the cavity 404. Alternatively, a disposable basket is selectively attached to a connector body via the at least one arm and complementary attachment point on the basket.
2) A liquid (e.g., water) is added to a pre-existing vessel 402 either before or after the apparatus is positioned at least partially in the cavity 404 of the pre-existing vessel 402. The amount of liquid added is the choice of the end user; however, the basket 408 should at least be partially submerged in the liquid to ensure proper interaction between the solid ingredients and the water.
3) The user activates at least one heat source (e.g., on the pre-existing vessel 402 or on the apparatus 400) in order to increase the temperature of the liquid to between 180 degrees F. and 200 degrees F. Most preferably, the temperature of the liquid is raised and maintained at approximately 198 degrees F.
4) When a temperature of the liquid in vessel reaches a desired brewing temperature (e.g., 180 degrees F. to about 200 degrees F.), the controller 418 activates the means for agitating 410 the basket 408 and commences operation. The motor 414 activates and the basket 408 is agitated in the liquid via the linkage 416. The baffle 700 ensures that the water in the basket 408 is sufficiently agitated and that the coffee grounds do not remain stationary inside the basket 408 during operation.
5) When the brewing of the beverage is complete, the controller 418 ceases operation of the means for agitating 410 the basket 408. Thus, agitation of basket 408 ceases, and the brewed beverage is ready.
6) The brewed beverage may be enjoyed by the user from the pre-existing vessel 402 directly in instances where the vessel is, for example, a coffee mug. Alternatively, the brewed beverage may be dispensed from the pre-existing vessel 402 to a second vessel for enjoying the brewed beverage in instances where the pre-existing vessel 402 is, for example, a large urn.
7) The coffee grounds may be removed from the device and disposed of by the user.

The brewing process for the apparatus of the fourth embodiment includes the following steps:
1) A first solid ingredient (e.g., coffee) is added to the basket 508, unless the basket is already pre-filled. Basket 508 is affixed to the linkage 516 or connector body 814.
2) A liquid (e.g., water) is added to the cavity 522 of the vessel 502. The amount of liquid added is the choice of the end user.
3) The basket is positioned in the cavity 522 of the vessel 502 such that the basket 508 and the first solid ingredients are at least be partially submerged in the liquid to ensure proper interaction between the solid ingredients and the water.
4) The apparatus 500 may be positioned in a room temperature environment or a colder environment, such as a refrigerator.
5) The user provides input to the controller 518 and, in turn, the controller 518 activates the means for agitating 509 the basket 508 and commences operation. The motor 514 activates and the basket 508 is agitated in the liquid via the linkage 516. The baffle 700 ensures that the water in the basket 508 is sufficiently agitated and that the coffee grounds do not remain stationary inside the basket 508 during operation.
6) When the brewing of the beverage is complete, the controller 518 ceases operation of the means for agitating 509 the basket 508. Thus, agitation of basket 508 ceases, and the brewed beverage is ready.
7) The brewed beverage may be enjoyed by the user from the vessel 502 directly. Alternatively, the brewed beverage may be dispensed from the vessel 502 to a second vessel 506 for, e.g., storage and/or dispensing.
8) The user may remove the coffee beans from the device and dispose of the product.

Application to Other Brewed Beverages

The present invention's primary goal is to provide an apparatus and method to enable consumers to more efficiently and economically brew higher quality coffee than can be brewed using the coffee making systems that are currently available. As such, much discussion of the present invention is framed in terms of brewing coffee. But it should be understood that the present invention may be used to brew other beverages in addition to coffee. For example, as many of the same principles that apply to brewing coffee also apply to brewing tea, a user may utilize the apparatus and method disclosed herein to make tea.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A basket for holding coffee grounds, comprising:
a frame defining at least one outer wall, the outer wall defining an enclosed interior volume;
an amount of coffee grounds positioned in the interior volume of the frame;
at least one attachment point on a side of the frame, the at least one attachment point having an opening sized to receive a complementary connector provided on a coffee brewing machine;
wherein the frame includes a plurality of openings;
wherein the plurality of openings generally permit water to ingress and egress the frame during a coffee brewing process; and
wherein the plurality of openings substantially prevents the amount of coffee from exiting the frame during the brewing process.

2. The basket of claim 1 wherein the basket includes at least two attachment points.

3. The basket of claim 1 wherein at least one of the attachment points defines a through opening.

4. The basket of claim 1 wherein at least one of the attachment points defines a substantially enclosed cavity.

5. The basket of claim 1 wherein at least a portion of the basket frame is made from bamboo.

6. The basket of claim 1 wherein at least a portion of the basket frame is made from plastic.

7. The basket of claim 1 wherein a direction of entry into at least one of the attachment points is generally parallel to the horizon during normal use.

8. The basket of claim 1 wherein a direction of entry into at least one of the attachment points is generally perpendicular to the horizon during normal use.

9. The basket of claim 1 wherein at least one of the at least one attachment points is intended to receive the complementary connector via a press fit connection.

10. The basket of claim 1 wherein at least one of the at least one attachment points is intended to receive the complementary connector via a positive engagement.

11. A machine for brewing coffee, comprising:
an interior volume intended for receiving an amount of water and a basket containing an amount of coffee grounds;
means for selectively agitating the basket; and
a connector body intended for selectively attaching the basket to the machine, a connector including at least one arm having a distal end, the distal end being shaped and sized for insertion into a complementary attachment point located on the basket.

12. The machine for brewing coffee of claim 11 wherein the means for agitating the basket rotates the basket.

13. The machine for brewing coffee of claim 11 wherein the means for agitating the basket oscillates the basket.

14. The machine for brewing coffee of claim 11 further comprising a heat source.

15. The machine for brewing coffee of claim 11 further comprising a power source.

16. The machine for brewing coffee of claim 15 wherein the power source is a battery.
